(19) United States
(12) Patent Application Publication
(10) Pub. No.: US 2013/0046580 A1
(43) Pub. Date: Feb. 21, 2013

(54) COMPUTERIZED, PULL BASED, EVENT SCHEDULING APPARATUS AND METHOD

(71) Applicants: Michael Lynn Harker, North Salt Lake, UT (US); Ricardo Diaz Barrozo Netto, Salt Lake City, UT (US)

(72) Inventors: Michael Lynn Harker, North Salt Lake, UT (US); Ricardo Diaz Barrozo Netto, Salt Lake City, UT (US)

(21) Appl. No.: 13/589,138

(22) Filed: Aug. 18, 2012

Related U.S. Application Data
(60) Provisional application No. 61/525,152, filed on Aug. 18, 2011.

(51) Int. Cl. G06Q 30/02; G06Q 10/04

(52) U.S. Cl. 705/7.31; 705/7.29

(57) ABSTRACT

A computerized apparatus and method may “pull” an event to a city rather than it being “pushed” by promoters. The system manages athletic matches, concerts, and other entertainment events requiring performers (the talent or act), a venue at a city, and ticket sales to attendees who pay the box office or “gate,” processing suggestions, voting, weighting of votes based on previous histories of customers purchasing and preference information. Later purchases substitute for votes in engaging customers to attend proposed events, which may still be cancelled if projected threshold sales are not met. If insufficient attendance is determined by the computer at a pre-determined deadline, the system cancels the event and issues refunds in cash, kind, discounts, or the like.

### RELATED CASES

This application claims the benefit of U.S. Provisional Patent Application No. 61/525,152, filed on Aug. 18, 2011, which is incorporated herein by reference in its entirety.

### BACKGROUND

1. The Field of the Invention

This invention relates to computer software, and, more particularly, to novel systems and methods for determining, scheduling, and executing public events.

2. The Background Art

Events, such as concerts, races, athletic competitions, and the like are commercially available primarily through promoters. For example, tour managers will work with agents and agents will work with various promoters to put together a schedule or a tour of various events. The events may be a succession of different performances by different performers. Other times, a tour manager in conjunction with a group of promoters, will develop a tour for a single band, orchestra, or other entertainment talent. Accordingly, the promoters will arrange for dates and venues for performances throughout the tour.

Many fans who would like to attend a concert or other entertainment event presented by a favorite band or other talent will often not be considered because their cities may be too small. A tour is set up between very large cities, and no smaller towns are considered. In other situations, there may be days when a talent could be available, but the logistics of developing the performance dates and venues is considered too risky or not worth the effort.

It would be an advance in the art to develop a system and method whereby computer systems can collect data, analyze inputs, and render decisions on a “pull” basis, rather than a conventional sponsorship and “push” basis where the risk is taken by a band and a promoter. It would be a further advance if a networked computer system could be programmed to provide website information, receive feedback as well as suggestions as inputs, and analyze that data using demographic data reflecting the probabilities of participation by individual fans or followers of a particular performance talent. Rock bands are one case in point, but agents for bands, orchestras, singing groups, comedy acts, races, rodeos, and other performers generally may benefit from the collection, analysis, decisions, and administration done by a computer systems, obtaining and relying on data specific to a talent, a fan, a type of fan, a population, a city, and so forth. Events can be planned, polled, calculated, measured, predicted, supported, committed to, offered, and thereby “pulled’ rather than being “pushed” into a venue, a city, a market, or the like.

### BRIEF SUMMARY OF THE INVENTION

In view of the foregoing, in accordance with the invention as embodied and broadly described herein, a method and apparatus are disclosed in one embodiment of the present invention as including a network computer system operative over the internet for receiving inputs from potential attendees (users, customers, fans, etc.) in order to acquire information from prospective attendees, develop potential tour stops including venues and dates for particular events and talent, and analyzing the feasability of scheduling such an event.

In certain embodiments, the voting of potential attendees (fans, followers, customers, buyers, etc.) may determine the flexibility of a city. Accordingly, a competition between cities, or simply a go/no-go decision may be made regarding any particular city. In other embodiments, an entire concert tour may be scheduled according to the draw (pull) of a fan base or other customer base in a particular city, region, or the like. Thus, an individual event may be scheduled, or an entire concert (or other event) tour may be scheduled throughout several cities.

In view of the connectivity of many young computer users, it may be most credible for social media systems to be the electronic word-of-mouth distribution mechanisms for information. In embodiments of an apparatus and method in accordance with the invention, various pages may be presented on a web site. The web site may be accessed by various mechanisms including a web application, accessible through a browser, or through a server to a client. In other embodiments, a specific application may be downloaded to a smart phone or other electronic device in order to reduce bandwidth and minimize the processing requirements of the receiving electronic device.

A system in accordance with the invention, pages are presented having explanations to the user, navigation buttons and menus, as well as control buttons and links in order to provide for supporting inputs, voting, selections and choices, and so forth. In certain embodiments, a band may be the talent for a potential event. Each band that is a possible talent for an event may be listed in a wish list from which users may make selections and cast votes.

Likewise, individual web pages may be presented for cities, in which the talents, dates, and other information are presented to users for proposed upcoming events. Similarly, wish lists may be accessed by citizens of a particular city or region in order to obtain information and to cast votes in order to draw the desired talent to an event at the city's venue selected.

In certain embodiments, contests may be run by a computer system presenting to multiple cities the optional events. Relying on the votes and commitment of fans in a particular city in order to distinguish that city and thereby draw the talent to an event sponsored in that city the system collects a minimum “gate” (required amount) from the fans who have drawn the talent to that event in their city's venue.

In certain embodiments, an entire tour may be scheduled by a computer operating with information about the potential candidate cities, each with its prospective venue, based on the actual ticket sales of front-end-tickets. Front-end-tickets are based on an increased (premium) cost to supporting fans, in order to assure the gate amount required to bring a concert to the city. After the minimum “front-end” or “gate” has been collected, then conventional box office functionality may sell tickets at a reduced (market) price.

Risk allocation may be made by the computer system in order to minimize the risk to all involved. For example, if front-end-ticket buyers are unsuccessful in reaching the minimum amount of money required to bring the desired talent to an event in their city, then refunds in full may be made by the system. The date is released, the venue is released, and the talent is released.

Thus, the computer system may effectively execute an option on a talent, at a venue, for a date, in a city. The option is then effectively sold by the computer system by on-line presentations to potential buyers or users. These buyers and users are attendees who are willing to pay a premium price or beyond premium price, to assure that the talent does perform at an event in their city.

When the minimum required amount has been posted by the fan base in and near the city of the performance venue, then the option will be exercised. Accordingly, the venue in the city along with its scheduled time slot is already locked in by contract through the option. Likewise, the talent has been contracted, and upon notification of the fulfillment of the minimum subscription for tickets, each contract moves forward from an option to being exercised and the contract executed.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a hardware suite for implementing an apparatus and method in accordance with the invention;

FIG. 2 is a schematic block diagram of an Internet and cloud-based system for implementing a method in accordance with the invention;

FIG. 3 is a schematic block diagram of software modules in memory of a computer system in accordance with the invention in order to execute the functionality in accordance with the method;

FIG. 4 is a schematic block diagram of communication processes between various software modules in accordance with the invention;

FIG. 5 is a schematic block diagram of a process for developing and operating an event in accordance with the invention;

FIG. 6 is a schematic block diagram of operation of a process of FIG. 5;

FIG. 7 is a schematic block diagram of one embodiment of a process for detecting, determining, analyzing, and delivering content in a format to users implementing a method in accordance with the invention;

FIG. 8 is a schematic block diagram of various pages, and also serves to illustrate schematically the underlying database records that may be stored and presented, respectively, in an apparatus and method in accordance with the invention;

FIG. 9 is a schematic block diagram of one embodiment of a web page for a city, a city page, in accordance with the invention;

FIG. 10 is a schematic block diagram of an “about” page in accordance with one embodiment of an apparatus and method in accordance with the invention;

FIG. 11 is a schematic block diagram illustration of an event page or “gig” page;

FIG. 12 is a schematic block diagram of a screen shot of a “gig” page;

FIG. 13 is a schematic block diagram of a city record;

FIG. 14 is a schematic block diagram of a screen shot of a talent wish list;

FIG. 15a is a schematic block diagram of a screen shot of a user interface page that may be configured as a sign-up page, a sign-in page, a profile editing page, and a check out page, according to the information presented thereon;

FIG. 15B is a schematic block diagram of a screen shot of a user profile page or user profile record, wherein, as with substantially all the illustrations herein, a record and a page may contain some or all of the same information, since the record exists in a database, and the page is presented to a user on a computer screen, and may be populated based on the record content;

FIG. 15C is a schematic block diagram of a screen shot of an administration record corresponding to a user profile, as maintained by the system;

FIG. 16 is a schematic block diagram of a screen shot of a gig page showing therewith a leader board detail available to a user;

FIG. 17 is a schematic block diagram of a screen shot of a gig administration record, or an event administration record, where a gig is slang for an event promoted on a pull basis in accordance with the invention;

FIG. 18 is a schematic block diagram of a screen shot of a sponsor check out page, having an inset that shows the record on which a database may store additional sponsor information obtained through a sponsor page;

FIG. 19 is a schematic block diagram of a screen shot corresponding to a venue and thus the administration page of a venue just as records and pages corresponding to other entities, such as user profiles, talent or bands, specific events, and so forth;

FIG. 20 is a talent record, which may typically be embodied as a band record saved by a database, and used to populate the fields in a band or talent page presented by a system in accordance with the invention;

FIG. 21 is a schematic block diagram of a competition page presented by a computer, and likewise can represent the records of data that will populate such pages; and

FIG. 22 is a schematic block diagram of a screen shot of a grid presenting the development of ticket sales to individuals and potential sponsors, each of which may upload an image covering the number of pixels representing the amount of the ticket sales undertaken by that fan, sponsor, or other entity.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

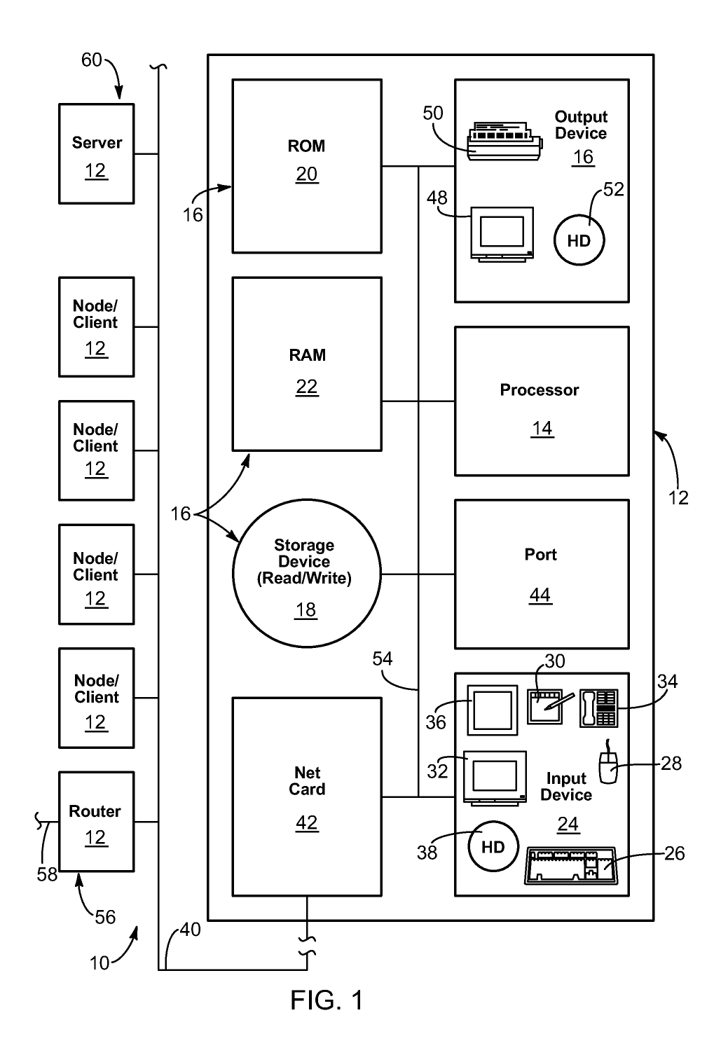

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

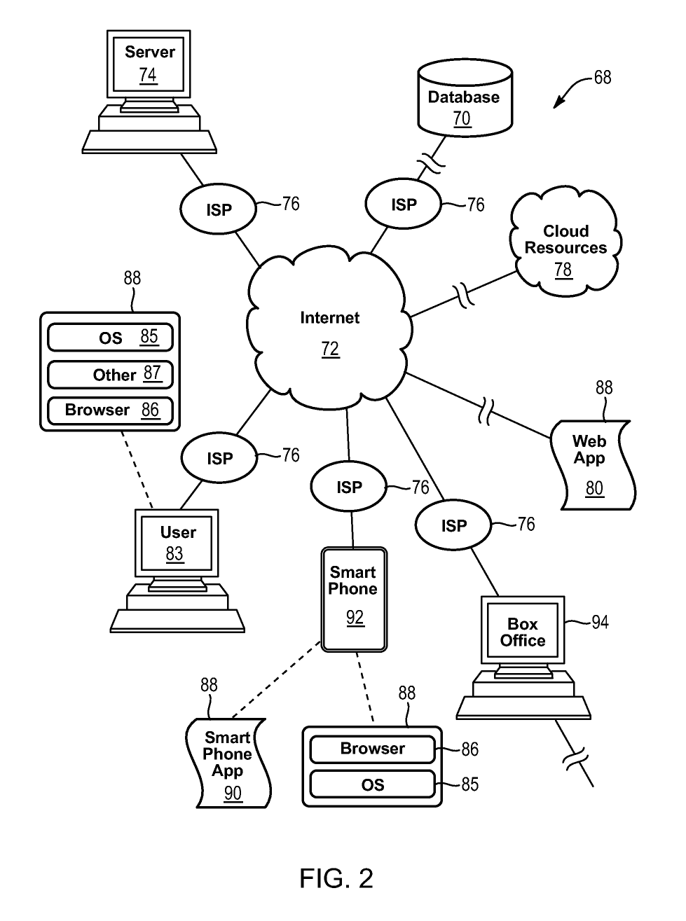

Referring to FIG. 2, a system 68 may include a database 70 for containing information. The information may relate to all the data required to execute an event. Typically, a database 70 may connect to the internet 72 in order to access or be accessible by servers 74. Each networked device owned by any entity, including the computer or computers hosting database 70 and the server 74, may connect to the internet 72 through an internet service provider 76 or ISP 76.

As a practical matter, servers 74 are not necessarily dedicated, full-time-on-line systems owned by a single entity. In view of the fact that many cloud resources 78 exist, including such items as servers 74, storage 70, and the like, services may be provided for the database 70, the server 74, the web application 80, or the like, by way of cloud resources 78.

Cloud resources constitute any combination of processors, software, storage, and access at will on a virtual basis rather than on a dedicated basis. The virtual resources exist, but connected only as virtual elements on demand, and therefore are freed up when not needed, for use by other users. Thus, one may think of cloud resources 78 as representing infrastructure, hardware, software, and the like, accessible to users over the internet 72 at some service cost, rather than by dedicated ownership and maintenance by a single user or entity.

In the illustrated embodiment, the resources served up by the server 74 may be delivered through a web application 80 that provides web pages for browsing by users. For example, a user may access a web page through a browser 86 as part of user interface software 88. The user interface software may include an operating system 85 on which the browser 86 operates. Similarly, other software 87 may operate on top of the operating system 85.

In the illustrated embodiment, a browser 86 may be launched from a computer of a user 82 connecting to the internet 72 through an ISP 76. In this embodiment, a user may rely on the browser 86 to operate a web application 80 available through cloud resources 78, such as a server 74, across the internet 72.

In other embodiments, a user may simply rely on a smart phone application 90 loaded on a smart phone 92, such as an Apple iPhone™, Blackberry™, Android™, or the like. Similarly, within the scope of computational facilities, the tablet computers that operate like a user computer 82, and yet have minimal requirements on bandwidth and operating systems, similar to smart phones 92, may also be used. Thus, by smart phone 92 examples included herein are meant any personal computing device that is internet enabled through an ISP 76 to access the internet 72.

For example, in addition to a smart phone application 90, a smart phone 92 may also host a browser 86. One benefit of an application 90 is that it may be dedicated and personalized, and do many tasks that a user desires, which are particular to the web application 80 that is to be run. In fact, many of the tasks of the web application 80 may actually be off loaded to the smart phone application 90. In other embodiments, the smart phone application 90 may simply be a very intelligent and highly programmed browser 86 that accesses resources from the database 70, the server 74, or the web application 80. In general, however, a browser 86 will typically be generalized, and will require a user to navigate on the browser 86 by way of the screen of a smart phone 92 in order to find a web server 74 or web application 80 that treats the browser 86 as a user at arms length.

In contrast, the smart phone application 90 may be customized, may be dedicated to both the functionality of the web application 80, and may even replace the web application 80, in order to deal with the database 70 directly, the server 74 directly, or the like.

Under this general proposition, the functionality of an application 80 may operate to schedule events on a “pull” basis. For example, all of the functionality of the server 74 may be available in a web application 80. In fact, the web application 80 may actually be hosted on a server 74. However, it may hosted on some other cloud resources 78.

Likewise, the database 70 typically need not be programmed to present the complete presentations to a user, but typically will store formats and content that will be assembled by the web application 80 in order to make presentations to a user.

Thus, in general, one may think of the application 80 as being the functionality in software, regardless of how and where that software is hosted. Indeed some or all of that software may be hosted in a smart phone application 90, on a application on a server 74 or elsewhere.

In certain embodiments, the user computer 82 may provide inputs, including purchase of tickets for an event sufficient to draw that event or “gig” to a city or other location desired by users 82. Accordingly, the mode of sales may shift from a “pull” system in which individual users must pay large, premium prices to assure that the “front-end tickets” or “gate” reaches the minimum level required for an event to occur.

Once the minimum is reached, then a box office computer 94 and the event web pages can continue to sell tickets at a reduced rate to “back-end-ticket buyers.” Back-end-ticket buyers are situated similarly to customers who buy tickets to conventional events that are pushed through promoters. Thus, although the web application 80 and all the similar equivalent embodiments discussed above, may continue to sell tickets, they will now have a lower price. That is, the premium subscriptions, once filled, are no longer necessary.

In fact, it is desirable to obtain as many conventional tickets as possible through a box office computer 94. Thus, the box office computer 94 may be one or more computers operated by one or more individuals or operating alone. For example, various venues have box offices operated by tellers or attendants who access the computer and sell tickets over the phone or by individual contact.

By the same token, electronic ticketing through various services is all ready available for events, such as sporting events, races, concerts, movies, plays, and other entertainment. Thus, any of those box office events could constitute an event in accordance with the invention. Each may be subscribed on a “pull” basis in accordance with the information up-loaded from user computers 82. Upon achievement of a minimum gate or total amount required to bring the event, then a box office computer 94 may provide generalized ticketing information and pricing, as well as sales.

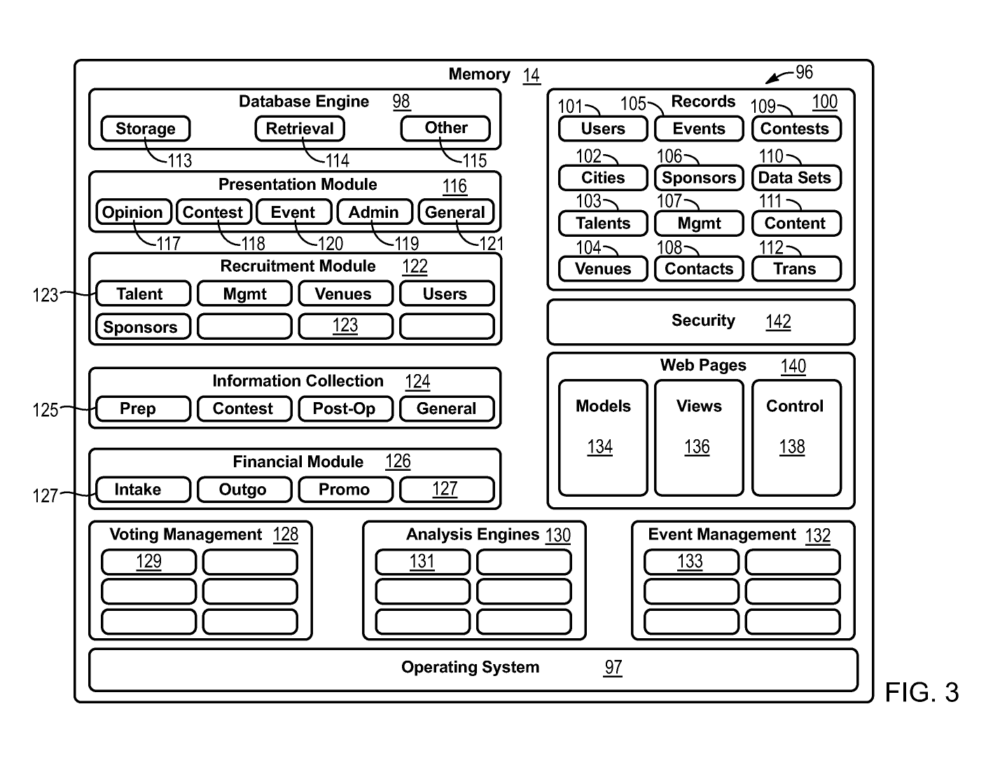

Referring to FIG. 3, in one embodiment of an apparatus and method in accordance with the invention, the system software 96 may include various software modules stored in memory 14. In accordance with the foregoing information above, the memory 14 is a computer-readable storage medium. However, the memory 14 may be distributed in any number of locations, including cloud resources 78, the database 70, the server 74, or elsewhere.

In one embodiment, a data base engine 98 may provide services for getting information in and out of the data base 70, sorted, filtered, indexed, and so forth. Likewise, records 100 may be stored in the data base 70 and correspond to various entities. For example, users 101, or user records 101 may be stored, likewise other data records 100 including for cities 102, talents 103, such as bands, orchestras, performers, and so forth, as well as venues 104 where events may be presented. Meanwhile, other data modules or records 100 may include events 105, sponsors 106 who are contributing to the promotion of events 105, and management 107.

By management 107 is meant the management entities associated with or serving other entities, such as venues, talents, and so forth. For example, a management company or agent may manage a particular talent, a band, a singer, a juggling act, or other spectator talent 103. Thus, the knowledge of the facts and information associated with such a management entity may be stored in the management record 107 or data module 107.

Likewise, the contacts module 108 or record 108 may involve the data for various contacts for management, talents, venues, sponsors, and so forth. Records for contests 109 may involve data specific to a particular contest launched by the server 74 or other application in order to determine which venues 104 a particular talent 103 may attend for an event 105. Various data sets 110 for control may be saved likewise, and may include numerous pieces of information, numerical formulae, and so forth.

Content records 111 may be stored in various modes in a data base 70 and may include everything from small numerical values to large blobs (binary large objects) and the like in order to stream data to a user computer 82 or user device 92 as desired. Meanwhile, transaction modules 112 may store numerous records 100 involving transactions, totals, verifications, security information and the like. Thus, in general, the records 100 may include any and all information necessary or desirable in order to operate a contest for scheduling a band 103 or other talent 103 to be drawn into an event 105, or the execution of the marketing, the box office work, the event, and so forth.

The data base engine may have executables such as a storage module 113, a retrieval module 114, and other modules 115. For example, a data base engine 98 may need to sort, filter, index, query, and present information as part of the operation of the storage module 113 and retrieval module 114 responding to queries of user. In fact, the data base engine 98 may include various accelerators, tables, indices, dictionaries, and another query management systems in order to optimize searches. Various types of searching algorithms and data structures, such as tables, dictionaries, and the like may be used by the data base engine 98 as part of its other 115 modules.

In general, by “executable” is meant either an adjective describing data structures that can be loaded into a processor and executed by the processor, or a noun. The word “executable” is used as a noun herein means a computer program or instruction of any size, that embodies processing logic and is executed by a processor in order to accomplish some programmed function of that executable. Thus, whether a single machine level instruction or half a million lines of computer code, an executable is set of logical instructions processed by a central processing unit of a computer in order to execute some intended functionality.

The presentation module 16 may include numerous modules for presenting web pages to users, sponsors, agents, and other entities. For example, an opinion module 117 may present information to collect opinions or votes. Similarly, a contest module 118 may present information and execute the functionality of a contest 118 between various groups of identifiable users. Similarly, an event module 120 may operate to present event pages and identify particular “gigs” 120 that will be competed for, or will be executed. Similarly, an administrative module 119 may handle the administration of the presentation module 116, or other administration that must be handled in order to assure that presentations may be made. Thus, other general functionality may be embodied in one or more general modules 121 in order to present information to the user computer 82 or other computer device in a system 68 in accordance with the invention.

A recruitment module 122 may be or include various modules 122, such as may be required to draw information about resources like talent, venues, and managers, and store it in the data base 70. For example, a recruitment module may involve handling of data, including collection, processing, or the like for information related to attracting talent, identifying management of various talent, obtaining information and maintaining it for venues, users, sponsors, and others that may desirably be drawn to connect to the data base 70. The module 122 may specifically connect to the server 74 by whatever mechanism required, such as the web application 80, smart phone app 90, or the like, in order to become part of and identified with the system 68.

That is, every web site on the internet that presents information through the browser 86 of a user computer 82 or other personal computing device 92 may present information. However, obtaining information back is extremely important for preparation and presentation of possible events. Accordingly, a recruitment module 122 may contain executables responsible for drawing in the information and participation from various user computers, whether those users are financial sponsors, ticket buyers, venue owners, management of talent, or talent.

An information collection module 124 may collect data useful for preparation, contests, management, post-operation data collection and data processing, and other general matters. In general, a system of sub modules 125 may facilitate collecting specialized information from ticket buyers, talent, talent management, venue management, potential ticket buyers, sponsors, and so forth.

Likewise, a financial module 126 may include several sub modules 127 involving intake of funds, outgo of funds, promotional expenses, and the like. In general, a financial module 126 may be responsible for accounting and analyzing the purchases by user computers 82, ticket purchases from users through user computers 82, as well as paying back refunds, paying the venue management, paying the talent, and so forth. Likewise, a financial module 126 may be responsible for receiving receipts of funds electronically and accounting for those that are received physically at physical box office locations serviced by a box office computer 94.

The voting management module 128 may include various sub modules 129 required or desirable to handle the collection of voting information, the weighting of information and votes, and so forth. For example, in one embodiment of an apparatus and method in accordance with the invention, voting management 128 may be responsible for calculating the number of votes that will be credited to a user.

A user through a user computer 82 or other personal computing device 92 may purchase any number of tickets desired. Similarly, a sponsor may purchase any number of tickets desired. Sponsors will typically pay a sponsor premium, because sponsors will be provided advertising opportunities.

The voting management module 128 is responsible for obtaining opinion information. For example, users may go online and identify, select, or suggest potential venues and potential talent for events. According to a user's history, a user may be given more than one vote. For example, a user may be a real fan who attends many concerts by a particular band. Accordingly, that user may be provided more votes based on the user's history of promoting events, sharing events, attending events, buying tickets for events, and so forth.

When talking about sales, a ticket sale is a vote of sorts. This is, perhaps, the traditional putting one's money where one's mouth is, by buying tickets through their user computer 82 or other device 92. They may purchase tickets, but each ticket purchased is only what it is, a ticket. Selling box office tickets through a box office computer 94, no ticket is any more valuable than another. The fact that one particular user desires more than another to see a particular band come to a specific venue is irrelevant in the cost equation of whether a band can be sponsored by its fans to come to a particular gig in a particular city.

However, in terms of gauging and predicting possible interest, influence of fans who have demonstrated a purchase history, attendance history, a word-of-mouth advertising history through social media, and so forth may be weighted much higher. This weighing may be implemented by giving additional vote counts to such individuals for purposes of determining popularity or likely support when considering potential bands, venues, events, and so forth. Thus, voting management 128 may process much more than simple clicks sent in from user computers 82.

Many analyses are required and enabled by the various modules in accordance with the invention. Accordingly, analysis engines 130 including numerous sub modules 131 may analyze data from voting on bands or other talent to come to a venue Likewise, demographic data collected in the information collection module 124 may be analyzed by the analysis engines 130, as may any data that can be learned by crawling the web, learned from promotional information sent by bands or other talent sources including their management, and so forth. The analysis engines 130 may be quite sophisticated in their ability to analyze and present information.

As a practical matter, the information collection module 124 may be responsible for collection of information from users, from bands, or other talent, from management companies and agents, from web crawling, and so forth. This may be needed in order for the analysis engine 130 to process that information to obtain a history and a prediction of the performance of certain bands or other talents in certain venues, at a certain frequency, to a certain fan base, and so forth.

The event management module 132 may have numerous sub modules 133 to manage the actual execution of an event. Typically, an event is constituted by a talent performing at a time and a venue for a group of paying attendees (e.g. users or customers) and possibly augmented by payments from various sponsors who obtain advertising opportunities associated with the event.

In some embodiments, web pages 140 may be stored to be displayed by or executed directly on an operating system 97. In one embodiment, web pages 140 may be saved and assembled by the MVC (model, view, control) process. Accordingly, a model 134 includes the content for a web page. Meanwhile, a view 136 of a web page constitutes the template or the arrangement in presentation locations pre-selected for the content provided by the model 134.

Meanwhile, certain executables called controls 138 in a control module 138 may provide the operational control for clicking buttons, receiving information, presenting information, and so forth to coordinate and control the placement and timing of the information from models 134 into views 136 for presentation to a user.

In some embodiments, the web pages 140 may be managed by the presentation module 116, or at least their presentation may be managed by a presentation module 116. In other embodiments, the control module 138 may actually supersede the presentation module 116, thus making everything web-page based, and the control 138 representing the programming for many of the other modules discussed herein.

A security module 142 may maintain security, such as by authenticating passwords, handling purchase information for the financial module 126, verifying that users are who they say they are, as well as keeping track of hardware 82, 92, 94 from which users may access the system 68, and so forth. In general, the security module 142 may be thought of as those logical, executable, software modules responsible, whether consolidated in one location, or distributed throughout various other software modules in order to effect the security of the system 68.

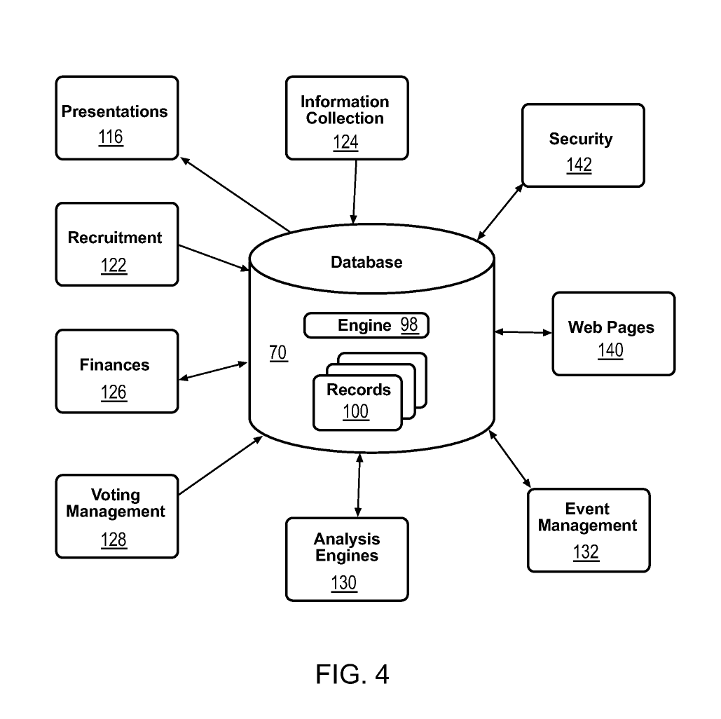

Referring to FIG. 4, the data base engine 98 may communicate directly to the other modules illustrated in FIG. 3. Typically, a data base engine 98 is responsible for maintaining records 100 corresponding to all information to be stored. Accordingly, information in presentations may be sent out to a presentation module 116. Similarly, information may be received from an information collection module 124. Similarly, security information may be exchanged with a security module 142 in order to store information, check information, authorize information, particularly accessing the data base 70 itself.

Of course, access to the data base 70 may be restricted to only certain modules, which may operate through the security module 142 or with the authorization of the security module 142. Thus, the recruitment module may send to the data base 70 information that has been acquired, and may receive information typically from a user, in response to the presentation module 116 presenting information. A recruitment module 122 may be absorbed into the processes of presenting information trying to motivate suggestions for events or improvement, and then collecting information in response to those motivations. Thus, the recruitment module 122 may actually be linked to or embodied in the presentation module 116 and the information module 124. By the same token, any module may be thought of as presenting information to the user computer 82 or other computer 94, and a presentation module 116 may implement details common to all those procedures for stimulating the collection of information coming back.

The financial module 126 may exchange financial information with the data base 70, which may keep records 100 regarding transactions, individuals, entities, and the like, from users to management, to talent, to venues, and so forth.

Likewise, the voting module 128 may provide data to the data base engine 70, which will store it on records 100 to be used by an analysis engine 130 later. Similarly, event management modules 132 may provide the administrative support needed to store records of sales, contests, and the like.

In general, web pages 140 may communicate back and forth with the data base 70, which may populate the web pages with information from records 100. Likewise, various web pages 140 may collect information, through buttons, selections, inputs, and the like. Input executables may be managed or executed by the information collection module 124 in order to select, analyze, fill in and otherwise process data to be stored in records 100 of the data base 70.

Likewise, the security module 142 may be distributed or consolidated to control access to the data base 70, and may monitor all web page interactions 140 to protect the system 68 against attack.

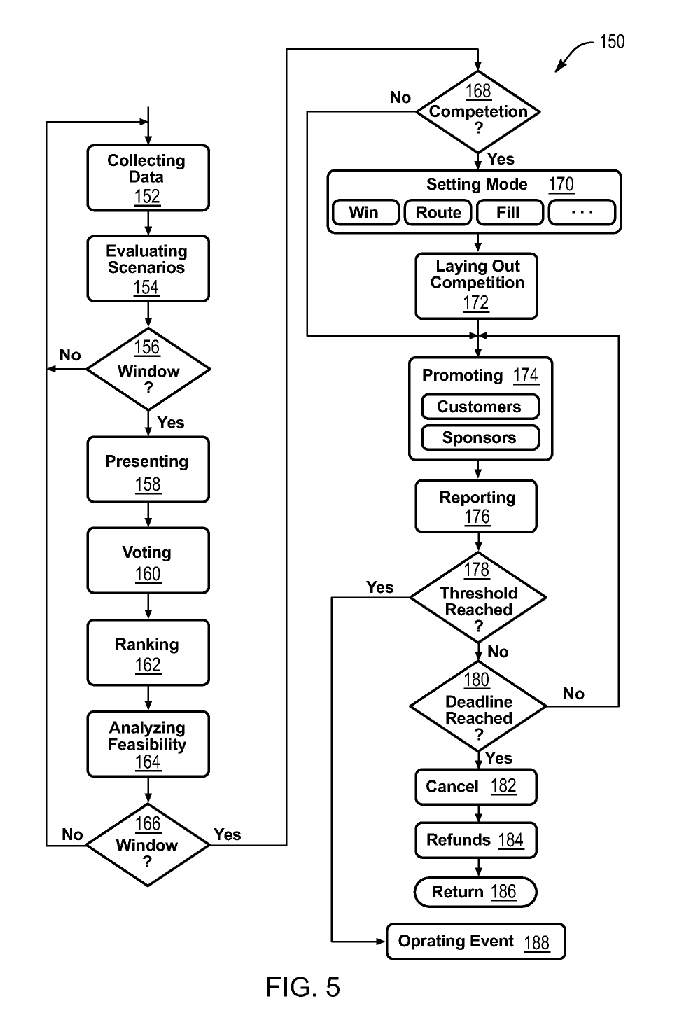

Referring to FIG. 5, a method in accordance with the invention may typically begin with collecting 152 data. Typically, the collecting step 152 is particularly important in obtaining information from potential attendees at an event. This may include analysis, parsing, selection, matching criteria, mining, direct inquiry, or the like. Nevertheless, collecting 152 (by selection, analysis, parsing, matching, etc.) data may be a continuing process through any or all stages of any or all executables in the system 68. Nevertheless, at a minimum, collecting 152 should typically include acquiring and processing information from user computers 82, accessing a server 74, web app 80, or the like. A web app 80 is used here as a representative application, representing any and all of the different embodiments of mechanisms to process information directed to users.

Typically, collecting data 152 may be a result of users browsing web pages 140, and making selections or typing in inputs into selected locations on the web pages 140. Accordingly, after collecting 152 data, then evaluating 154 may include evaluating 154 various scenarios. At this point, an analysis engine 130 may be very helpful to process voting information from prospective ticket buyers, as well as evaluating 154 information received from venues, bands or other talent, and so forth.

For example, putting together combinations that will result in satisfied fans, comfortably full coffers, and the like may involve an ongoing evaluating 154 of data including fitting curves or equations to past data by various numerical methods solutions in order to determine the relationship between desired outcomes and available input information.

Data may be processed, ranked, categorized, and generally analyzed and linked to corresponding individual groups, populations, users 101, cities 102, talent 103, venues 104, events 105, sponsors 106, talent management 107 or other management 107, individual contacts 108, the results of various contests 109, the response to various content 111, and particularly the results of various transactions 112. Evaluating 154 may result in curves, charts, graphs, or other analytical representations of measurements, predictions, classifications, and so forth, relating to the statistical probabilities of the participants, financial numbers, and general success for gigs 105 or events 105 managed by the system 68.

After evaluating 154 various scenarios for potential events combining a fan or customer base with a band or other talent at a venue, a test 156 determines whether a window of operation exists. By window of operation is meant a set of controlling parameters that define at least one result possible, or having a probability above a necessary threshold.

For example, if a talent and a venue cannot be coordinated on a particular agreed day at an agreed time, then there is no process, no operating window, and the test 156 fails. By the same token, if ten dates are available at a particular venue, and a band or other talent can meet eight of those, then an operating window to meet exists. A yes or a value above a threshold may then lead to presenting 158 information to potential customers. Presenting 158 involves presenting a venue, date, time, ticket pricing, or more, in particular, talent. Presenting 158 by the server 74 or application 80 or the like, to a user computers 82 provides users the opportunity to see what potential events they might be able to attend. Data for analysis is needed to quantify event facts.

In some embodiments, evaluating 154 may be a matter of evaluating markets, details of demographics, data from previous events of a similar nature, and the like. This is at least in part because putting together an event is an iterative process. Iteration is a repeated calculation, testing of a result, and possible modification of inputs based on previous analysis, followed by further analysis in search of a suitable solution. If a fan base for a particular talent is simply too small and the population of the region around the venue is too small, it may not pass the feasibility window test 156.

Similarly, if a wildly popular talent is available, but the minimum gate requirement cannot be met due to the small seating capacity of a venue, then that venue may simply not be able to support a window of operation within the realm of feasibility. Numerous other factors may be considered in evaluating 150 and analyzing various prospective scenarios.

Thus, when presenting 158 scenarios to users, such may be presented in the form of wish list. For example, a proposed set of bands may be presented to users. In other situations, bands with a month or a venue may be presented. Ultimately, the determination of desires of attendees is a functional result of operation of the server 74 or its equivalent obtaining voting 160 that ranks the various events and scenarios that have been presented 158.

Once voting 160 has begun, ranking 162 may begin. In some embodiments, voting 160 may be completed before any ranking 162 is undertaken. However, to the extent that data may be analyzed, ranking 162 may be undertaken as soon as sufficient voting 116 has occurred to lean toward some prediction.

Ultimately, analyzing 164 the feasibility of a particular event may involve financial considerations, demographic considerations, the match up of talents with supporting populations, and ticket prices at particular venues with their seating capacities, and so forth. Thus, ranking 162 may actually involve numerous parameters relating to all details mentioned herein as characterizing an event, and any and all analyses of the known or projected values of those parameters, included in the analyzing 164. Nevertheless, voting 160 and weighting of individual votes may typically be included in development of the analysis for a ranking 162.

However, other weighting factors also may range from significant to overwhelming. Notwithstanding the Woodstock concert, famous for its accumulation of some half million attendees, most small towns lack the population and infrastructure for large assemblies of attendees. Thus, analyzing feasability 164 may involve analyzing attendees, potential attendees, talents, venues, ticket costs, minimum box office receipts required, timing between events in the region, competing events for the time slots, even though at the same venue, and the like. Many other similar factors may be involved in analyzing 164 the feasibility of the highest voted or the highest ranked 162 event.

Likewise, voting 160 may simply apply to one part of the event preparation at a time. For example, voting may be held for venues. Voting 160 may be held for talent. Voting may also be done on the basis of dates. For example, if a band can play at a particular venue on any of two or three dates, then some or all of the visitors to the web page may be requested to vote on the time, the location, the talent, or any number of event parameters. Each voter may have a weighted vote based on an analysis of that voter's actual performance (attendance, pricing, event type, etc.) thus providing data into an analysis of location, talent, timing, costs, and other parameters of a prospective event.

Nevertheless, the typical voting 160 is for particular talents. Therein lie the strongest feelings, the greatest motivations, and the biggest single opportunity and obstacle for presentation of an event.

Following analyzing 164 the feasibility, a test 166 determines the operational window, a set of conditions that will work, given the desired talent and other parameters resulting from the voting 160, along with the financial considerations, the negotiations for options for events, conducted with the entities from the management to talent to venues and the like.

If no process window exists, then a negative response returns a system 150 or process 150 to collecting 152 data. Similarly, the tests, 156 and 166 failure or negative outcome results in a return to collecting 152 additional data. In returning from each of the tests 156, the process 150 and system 68 may collect entirely different data.

For example, people may be permitted initially to put forth proposals for bands or other talents they would like to see. However, upon initial evaluation 154 of scenarios, all options may have to be revised. The present options may have to be disqualified. Similarly, after a detailed session or effort at analyzing 164, the group of options may be narrowed down. Alternatively, all options may be off the table and one may have to begin again.

Typically, a test 168 is a decision on whether or not to sponsor a competition. Competitions may not be required. If the test 166 reveals that the analysis 164 has provided a tractable, available option, no competition may be needed. On the other hand, depending on the process or operational window determined, it may be useful to compete between cities.

For example, if m cities would all like to have n events or n days available, and n is a much lower number then m, then very few of the cities can actually have the event. Likewise, any time the number of days available for a talent to be at a venue city is less than the number of cities, fewer cities will actually be able to sponsor the event or host that event. Thus, competitions may be required. If a competition is not going to be required, then one may go directly to promoting 174. This may occur because the talent for the venue coming on a particular date to the place, and other factors in the feasibility analysis 164, turn out positive.

On the other hand, if competition is required or desired, for any other business reason, whether to determine which city is willing to put up the most money, which city most quickly can reach the box office minimum requirement, or the like, setting 170 a mode competition may be required. A competition may involve a win by one city over another. In other events, where more than one or two or a few dates available. The question may be one of setting a tour route. For example, it is considered that fans may determine that among 20 concert dates, 20 cities can receive those concert dates. Any number of cities may compete for those concert dates. In this situation, both the date and the location of the city with respect to previous and subsequent concert dates will matter. Ticket sales may be used to develop a route, based upon a competition between cities to be placed on the route in a sequence, that will fit with the other cities on the route on their respective days.

Another mode determined by the setting 170 may include a “fill in” date. This is a typical situation where one or a few possible dates are still available on a concert tour already scheduled. One of several cities might be on a potential path between two other cities already scheduled. In this case, various cities may compete to be the venue to fill the date. Fans may bring the fill event for a single or one of a limited number of available dates already fixed by other tour dates. Other modes may also be set 170 according to the imagination and resourcefulness of planners.

After setting 170 a competition, laying out 172 the competition may involve the logistics of determining front-end-ticket prices for purchasers who are going to be supporting fans. These supporting fans are those who are willing to pay higher ticket price, perhaps as much as five or ten times as high as the market value of a conventional ticket price, in order to assure that their desired venue will host the event. Laying out 172 a competition may involve any number of details associated with arranging the time, place, the logistics, the financial payments, and so forth. Laying out 172 details of advertising the information, setting decision criteria, determining the communication links, the interfaces with the data base 70, and so forth are the responsibility of laying out 172 the competition process. Storing and using data in the database 70 may be required, in order to fit data, process information, and determine the outcome of decisions that can be very complex.

Promoting 174 may involve at least two groups including customers and sponsors. Customer promoting 174 involves selling an event to prospective attendees. Promoting 174 to sponsors involves recruiting companies who can benefit from advertising their sponsorship. For example, typical of any rock concert will be a local radio station desiring to promote the concert on the air, in return for a certain number of free tickets, or the like. Typically, promoters may pay for air time or may trade goods in the way of tickets for air time.

Thus, the advertiser will typically pay a premium on tickets amounting to an advertising fee. In return sponsors may receive several tickets they may give away as promotional items. Thus, the radio station may sponsor competitions or simply give away to the first callers on a contest line tickets.

Meanwhile, the promoting sponsor may also be permitted to put advertising on the event page 140 demonstrating the support of the sponsor. Typically, sponsors will pay a higher price per ticket, reflecting the advertising value, and will typically not be refunded if the event is canceled. That is, a sponsor receives the benefit of advertising. In contrast, a user who is participating in a contest to bring an event to a particular city receives a full refund, because that front-end-ticket purchaser has received no concert if the concert fails to materialize due to a lack of sufficient front-end-ticket buyers. Reporting 176 back to users and to the system 68, in a process 150, the results of promoting 174 activities will involve reporting 176 ticket sales of front-end-tickets.

Reporting 176 eventually results in testing 178 to determine whether or not a threshold amount of receipts have been received. If not, then the test 180 determines whether the date deadline has passed for exercising the options contracted with talent 103 and the venue 104 for the event.

If the threshold sales 178 have been reached, then a positive result to the test 178 results in moving on to operating 188 the event. On the other hand, if the threshold has not been reached, then the test 178 proceeds to the test 180 determining whether a date has been passed by which the option must be exercised. If the deadline has passed, then the test 180 results in cancelling 182 the event.

For example, if the minimum receipts have not been received in front-end-ticket sales, then the concert cannot take place. The deadline has lapsed, the option contract has lapsed, and cancelling 182 results in all individual ticket holders receiving suitable refunds 184.

Refunding 184 tickets does not include refunds of money to its sponsors. Sponsors were paying for advertising, and received that advertising on the web pages 140 of the system 68.

Refunding 184 of tickets is followed by a return 186 from the process 150 or may return the process 150 back to its initial stages of collecting 152 data for potential upcoming events.

Once the threshold has been reached, then the test 178 does not lead to the deadline test 180. Accordingly, once required front-end-ticket sales have been reached with the higher, premium-priced front-end-ticket, then operating 188 returns to a more conventional box office operation. For example, once the minimum required box office receipts have been assured, then ticket sales drop to the back-end-ticket sale price. The general public of market priced tickets is promoted. All are promoted or motivated to attend the event which now will occur because the options have been exercised with respect to the venue, the talent, the date, and the funding.

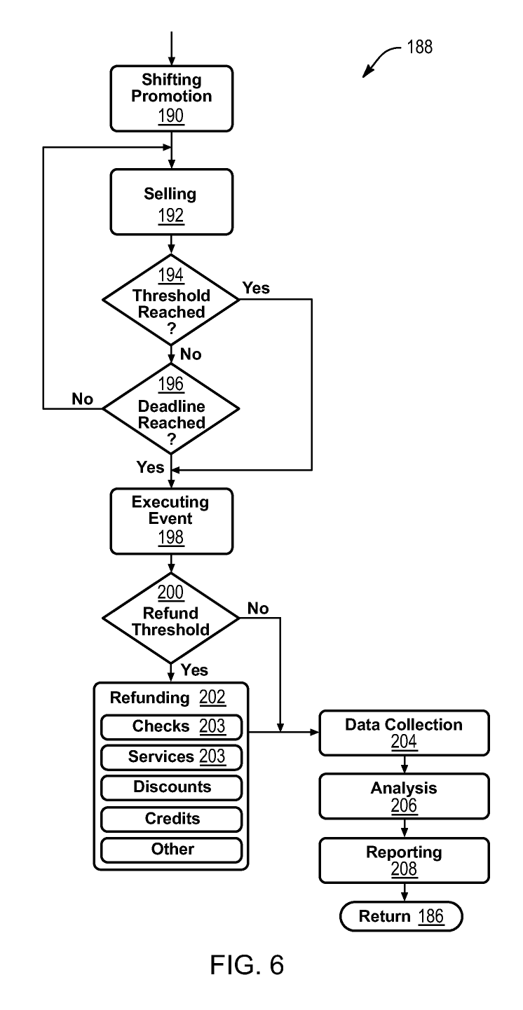

Referring to FIG. 6, shifting 190 the promotional activities is part of the operating process 188. By shifting 190 the promotional efforts, the move is made from front-end-ticket sales to conventional back-end-ticket sales. Accordingly, selling 192 through regular box office outlets begins. Many box office mechanisms may be relied upon, including on-line ticket sales through the box office computer 94, and continuing sales through various versions of the application 80. Such may be hosted on the server 74, or other locations on the web, including the smart phone application 90, browser accessible web sites, and so forth.

The significant change in the shifting 190 is the sale of conventional tickets at conventional (market) prices through conventional outlets. Eventually, selling 192 should result in meeting a threshold level of sales. A test 194 periodically runs on a processor 12 to determine whether sufficient sales have occurred. If all seats in a venue are sold out, then the threshold has been met. Typically, compared with the front-end-ticket sales, wherein a minimum money value of tickets must be sold, the test 194 is really more a matter of seating numbers. If a venue has no more seating, then the threshold has been met and test 194 is positive.

So long as a threshold has not been met by a test 194, then the test 196 runs for meeting the date deadline for ending sales. This test 196 evaluates the status of timing. Accordingly, the test 196 tests whether the last date for sales has occurred, which may be up to the time of the event itself.

For example, if a venue has sufficient seating, or festival seating wherein there are no assigned seats and participants or attendees are distributed across a lawn, then the deadline date may never be met until the hour of the actual event. Accordingly, upon periodic execution of the test 196, a negative result, meaning that the deadline has not come, results in continued selling 192 at box office outlets. Notwithstanding selling 192 occurs at the box office, selling does continue on the event page 140 as well.

Meanwhile, when the deadline for sales is reached, then executing 192 the event proceeds. Upon completion of all sales, and accounting for sales, various processes occur including paying the bills to the owners of the venue. Advertising revenues are collected if not previously collected, certainly the talent, such as a band or other performing group is paid from the proceeds, and so forth.

Thereupon, an accounting determines whether the refund threshold has been met. The test 200 determines whether sufficient profit was made to provide refunds to purchasers of the front-end-tickets. For example, if profits are nil, there is no money to refund to the front-end-ticket purchasers. As a practical matter, a venue may never have sold out. The event occur after enough front-end-tickets have paid to support the event. However, whatever amount of sales may occur after reaching that threshold determined by the threshold test 178, the event goes on.

If an event turns out to be quite popular, such as, for example, if the attendance threshold is met, and the test 194 returns a positive result, then the concert is a sell out. In such circumstances, there may be a refund due to the purchasers of front-end-tickets in whatever the amount the receipts will support. The front-end-ticket purchasers may receive a partial refund of their premium price ticket, a total refund, or may receive a refund greater than the amount of money paid for their front-end-ticket.

Refunding 202 may be in a form appropriate to the amount of refunding due. For example, the initial supporting or funding purchasers may receive checks 203 or other refunds 203 by way of services, such as tickets to other concerts. Similarly, they may receive discounts to other concerts or credits on an account. Meanwhile, refunds may use any other mechanisms for providing value. Typically, checks would be an appropriate refund 203 type if the amount of the refunds exceeds the amount of ticket price paid. Typically, if the refund threshold 200 or test 200 is barely met, and only a comparatively slight percentage refund is due to each purchaser of front-end-tickets, then a more cost effective mechanism for a refund 203 may be a discount or credit against future ticket sales.

After executing 198 an event, data collecting 204 followed by analyzing 206 that data may be an important part of improving the efficiency or effectiveness of the process 150 and the system 68 of the invention. For example, reporting 208 the results of the analysis 206 of data collection 204 to the parties responsible for maintaining the system 68 supports the on-going data base 70 of demographic information, sales information, performance information, costs, customer and mass market preferences, and so forth.

For example, some talent choices may appeal to a very small but very vocal and dedicated fan base. Other talent choices may appeal to a broader cross-section of a community. Both types of talent selections may have a place, but those places will involve different venues, different advertising effectiveness, different ticket prices, and the like deduced from the analysis 206.

Ultimately, some reporting 208 may be associated with the refunding 202. For example, reporting back to the individual users, and into the user records 101 stored in the database 70 permits individual attendees to post or share the information associated with their activities. Similarly, they may forward to friends reports, photos, and other information about the event, thus advertising for future events by the success of previous events.

By the same token, the web pages 140 associated with a user profile may automatically receive reporting 208, in order to update the knowledge of the system 68 stored in the database 70, by which voting power of individuals is determined, for example. Thus, the web page 140 associated with a user record 101 may reflect the gigs or events that this person has shared, has brought, has attended, and so forth. This information is not only helpful to the operators of the process 150 but also to the individual user who may wish to share with others their activities. Finally, the operating process 188 may return 186 following completion of reporting 208. For example, an event has occurred, has resulted in a successful event, for which data has been collected 204, analyzed 206, and reported 208. The general process 150 may then be repeated for other events.

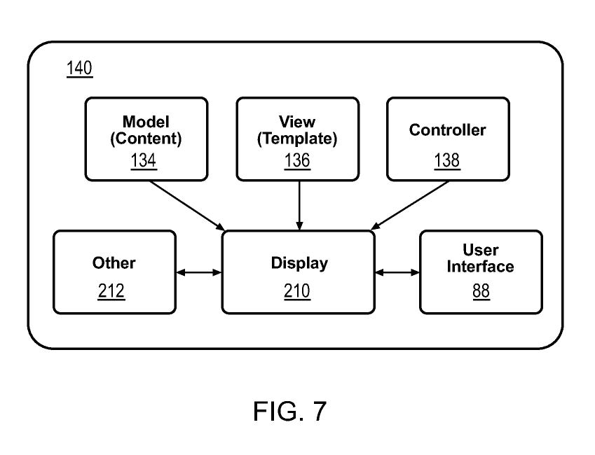

Referring to FIG. 7, a page 140 or internet page 140 of an apparatus and method in accordance with the invention may use a model or content 134 containing the information to be presented. This may be periodically changed using records 250 from the data base 70, and otherwise inform a reader of the page 140. Meanwhile, a view 136 or template 136 provides the layout or spatial arrangement of the information contained in the model 134. Executable instructions constitute the controller 138. The controller 138 may be hardware, software, or both but may typically embodied as command structures (instructions) within the web page, informing the computer how to operate on the template 136 and the content 134 in order to effect the presentation, collection of information, interaction with a user, and so forth.

The model 134, view 136, and controller 138 thus communicate to the display 210 or the display device 210. The display 210 is typically a computer display with processing to interpret and display a page 140. Thus, the display 210 may be thought of as the presentation on the page 140, or by the page 140.

Typically, a user interface 88 may interact with the user to receive inputs, including coding or keyboarded values that select content 134 through the controller 138. Likewise, other software elements 212 may interact with the display 210 to effect the display 210 to a user.

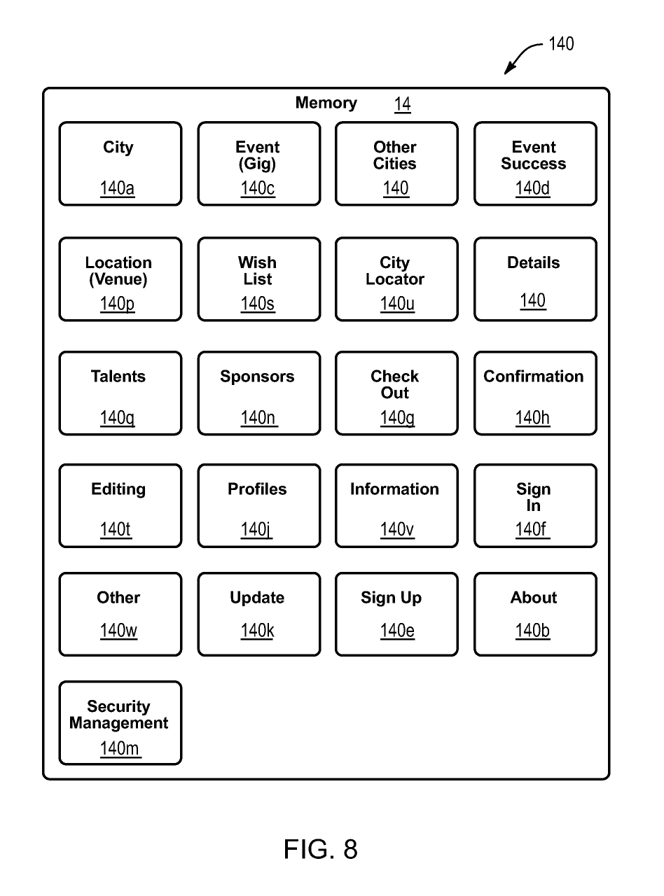

Referring to FIG. 8, the various web pages 140 may include various dedicated pages serving specific functions. For example, a city page 140a may present the information particular to a city. Similarly, a page 140b may simply provide information. This is commonly referred to as an “about page” 140b. Similarly, an event page 140c may include the particulars of a specific event or gig, while other city's pages may also discuss or provide information about alternative cities.

Similarly, a city locator page may assist a user to find a city at a destination. For example, a typical city page 140a will be produced by the display 210 as a direct result of the knowledge of where the user accessing it is located. This may come from the user inputting an address, global positioning system (GPS) information from a smart phone read into software, or the like. However, an individual may wish to locate a city where that individual may visit at a later time. Accordingly, a city locator page may be used for this purpose.

In certain embodiments, the event page 140c may be modified to an event success page 140d showing information particular to the event once the event has been scheduled for certain, due to sufficient ticket sales support.

A sign-up page 140e may assist a prospective user to sign-up for information, an account on-line, or the like in order to interact with the systems 68, and particularly with the software modules 96 that form part of the systems 68 executing the process 150. Similarly, a sign-in page 140f may provide previous users with rapid access to the pages 140 in accordance with the invention.

In certain embodiments, a check out page 140g permits a user, sponsor, or other to purchase tickets, purchase sponsoring advertising space or the like. Meanwhile, a confirmation page 140h may represent the check out page 140g or another page 140 that confirms that checkout has been successful.

In certain embodiments, users of a system 68 may desire to suggest or review other particular talent options. Accordingly, a wish list page 140j may include many details of potential or prospective new events or talent selections.

Meanwhile, a user profile page 140j may contain and present all pertinent information about a particular user accessing the system 68. A user profile may be controlled partly by a user through inputs to the systems, and to a certain extent by the system 68 itself which may pass information from the database 70 back to the user profile 140j in accordance with the activities of the user as detected and reported 208 in accordance with the processes 150, 188.

An update page 6 may be prepared for presenting screens, windows, fields, prompts, and the like, corresponding to any page 140. For example, an update page 140k may present information for a user, sponsor, or administrator, to input information permitted by their particular status to be used to update any particular page 140 to which an individual may have authorization for access.

Sponsor pages 140m may contain information regarding sponsors including contact information, advertising information, any of the advertisements, or other information desired or desirable by a sponsor. Similarly, an editing page 140n may provide an administrator, or other person having specific authority, with a page presenting information, editing buttons, and other controls in order to be able to edit what is required. In contrast to an update page 140k, wherein one may provide certain information, system controls may require more severe limitations on who can access editing page 140t abilities, controls, and access.

A security page 140m may provide a presentation and accumulation of information associated with security of the systems 68, or any of the pages 140 in particular. Meanwhile, venue pages 140p, just like sponsor pages 140n, may provide and accumulate information by interactions with users of all types, whether potential concert attendees, ticket purchasers, sponsors, administrators of the systems 68, or the like. This information is associated with any may provide information or control to a user or administrator. Talent pages 140q may present information, and collection, as well as selections, buttons, and the like. Certain standard functions may be provided in all pages 140, but also unique features associated specifically with a particular talent, such as a band. In this way, the talent page 140q may present, collect, control, access, navigate, and otherwise provide the information or collect information pertinent to a particular talent.

A competition page 140r may present, collect, control, manage, navigate, and otherwise support information related to a specific competition. By a combination of text, images, video presentations, and the like, user, administrators affiliated with the system 68, casual viewers, and the entities involved in an event may each have appropriate, and appropriately controlled access.

A general information page 140 may include information about the processes 150, 188, the system 68 or any other desirable or desired fact. In general, the pages 140 each provide information about a particular entity, event, or the like. Nevertheless, they may each be provided with an overall theme consistent with one another. This makes navigation simpler and easier for a user. Consistency, a common look, similar location of buttons and controls, and the like all contribute to the ability of a user to quickly and easily locate information desired and provide interactions such as personal information, selections, purchases, and so forth Likewise, navigation through menus may be facilitated by having them located in the same general area with each presentation of a particular web page 140.

In addition to the pages 140, any particular entity, whether an individual user, a business, a talent, a band, a sponsor, an advertiser, a venue management company, a talent management company, or the like may have a page 140w. Meanwhile, a record 250 may likewise be saved in the database 70, corresponding to any particular page 140, and specifically storing the model 134 or content 134 corresponding to that particular page 140.

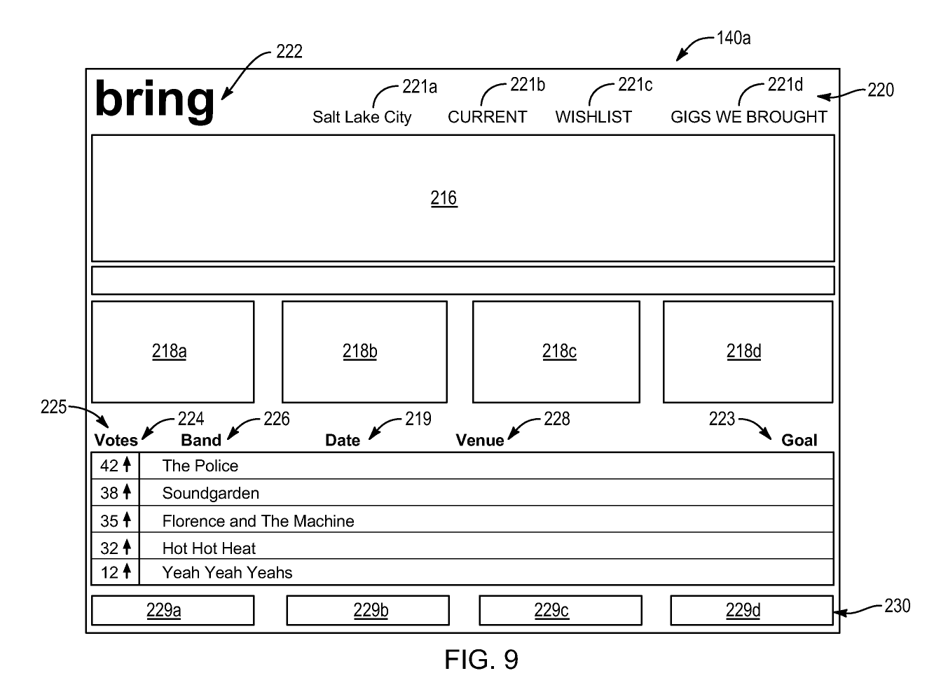

Referring to FIG. 9, in one embodiment of an apparatus and method in accordance with the invention, a city page 140a may be the first page 140 of any type seen by a user. In certain embodiments, the system 68, and particularly the application 80 or any version thereof, whether on the server 74, a personal device 92, a user computer 82 or the like, may present to a user a city page 140a immediately upon accessing by a user.

For example, the point of a home page for the system 68 is less valuable than the immediate presentation to a localized city page 148 corresponding to the city where a user, sponsor, or other entity is located. Thus, upon accessing the web site or home page, a user may be redirected immediately to a city page 140a showing the pertinent information corresponding to that city.

Referring to FIG. 9, a city page 140a may include a banner 216 associated with a particular talent that is currently being contested or promoted for an event associated with the city corresponding to the city page 140a. Underneath the principal banner 216, devoted to the currently contested talent that fans in that particular city are trying to draw to an event in that city, may be other potential or future talents represented in subordinate banners 218.

For example, the trailing letter following a reference numeral herein represents a specific instance of that numerical. Thus a reference numeral may be used, with or without a trailing letter, even in the absence of its solo appearance in text or a figure.

In FIG. 9, the subordinate banners 218a, 218b, 218c, 218d, for example, illustrate upcoming banners 218, corresponding to upcoming events. Thus, a principal or most timely contest for a particular appearance by a specific talent may be shown in the principal banner 216 while future or other potential talents are represented by images, videos, or the like in upcoming banners 218.

A header 220 or header menu 220 may include a menu 220 of specific buttons, hot links, informative text, or the like. For example, the city name 221a corresponds to the city for which the page 140a exists. Similarly, current events, contests, and the like may be represented by a current hot link 221b or a current button 221b. Similarly, the menu item 221c may provide a hot link 221c, button 221c, or other navigational aid 221c to access a detailed wish list from which one may pick, or to which one may add potential talents for consideration.

Similarly, a history button 221d or hot link 221d may provide access to a listing of specific talents, events, and the like that have previously come to the city corresponding to the city page 140a. This information can be useful for several reasons.

For example, the size and popularity of specific talent events may be indicated by the history found by navigating through the history button 221d. Similarly, if a specific talent has recently been to a specific city, then a reasonable time delay may be expected before any subsequent event presentation by that particular talent.

The logo 222, or other emblem 222 corresponding to the owner of the system 68 may be a prominent feature of each web page 140 associated with the system 68. Similarly, an information blurb, images, and the like may also be available. Similarly, under any of the buttons 221, or hot links 221, a user may click, may be presented other pages, other windows, other information, videos, pictures, photographs, other images, textual information, and the like.

In one embodiment of an apparatus and method in accordance with the invention, a city page 140a may serve the function of presenting the financial goals 223 corresponding to various additional contests. Typically, the main banner 216 may include a specific contest in which the city fans are competing to bring that talent. The main banner 216 may be directed to an event for which the system 68 is simply trying to increase attendance. That event has already has been shifted into the box office mode described in FIG. 6 with respect to the process 188.

Meanwhile, the particular vote count 224 may be presented along with the talent 226 corresponding thereto, and the proposed venue 228, corresponding to each. In certain embodiments, one may think of the votes 224 as a list 224 of voting, and the band 226 as a list 226 of bands. Similarly, a list of venues 228 may appear, corresponding to bands 226 or other talents and their respective goals 223 of financial commitment required to bring that talent 226 to that venue 228.

A footer 230 or footer menu 230 may present a menu 230 of various other buttons 229, hot links 229, or the like. Typically, each button 229a, 229b, 229c, 229d, may include specific information presented to a user, as well as a hot link or button on which a user can click to bring up more information, make a decision, navigate, or the like.

For example, in certain embodiments, the button 229a may show information about talents desired, or “gigs we want” in a particular city. Likewise, “gigs we brought” 229 may be illustrated in another field, button, presentation, or the like illustrated as the menu item 229b.

Similarly, an explanation of how the system 68 works, may be accessible through the right button 229c illustrating the basic information in a subsequent page to which a user may navigate by clicking on the link 229c to access it.

Sponsorship opportunities may be presented and explained on a subsequent page 140 navigated to by clicking on the link 229d or button 229d. Similarly, other information such as an “about page” 140b may also be accessed by a similar link 229d.

Thus, in general, a city page is devoted to events targeted to the user's city. The presentation 225 or list 225 may be thought of as a wish list 225, and be labeled as such. Thus, a user may immediately see the number of votes 224 required, for a particular talent 226, for a specific date and venue 228. A user may perceive some as within reach or out of reach, depending on what the goal 223 or total cost required is. Typically, a user may then consider both the goal 223, as well as the devotion to a particular talent 226, in view of the number of votes 224 achieved. Thus, an individual may make a multi-dimensional decision as to which particular talents 226 to support on the wish list 225.

The list 219 of dates 219 associated with particular talents 226 and venues 228 corresponding to city may be specific or general. For example, it is usually best to know a specific date, in order that a specific option may be contracted. A band on tour may have only specific dates available. Therefore, entries in the wish list 225 may actually include a single band on different dates 219. Dates 219 may be general, including a month only of a particular year. Nevertheless, it has been deemed more effective to have a specific talent 226, on a specific date 219 in a specific venue 228 on a wish list 225, in order that as many details as necessary may be locked in by an option contract. Thus, the event happens at the date 219, and venue 228, with the talent 226 specified, or it is not. Thus, a digital decision is much easier for an individual to deal with, a contract to deal with, and for the computer system 68 to deal with.

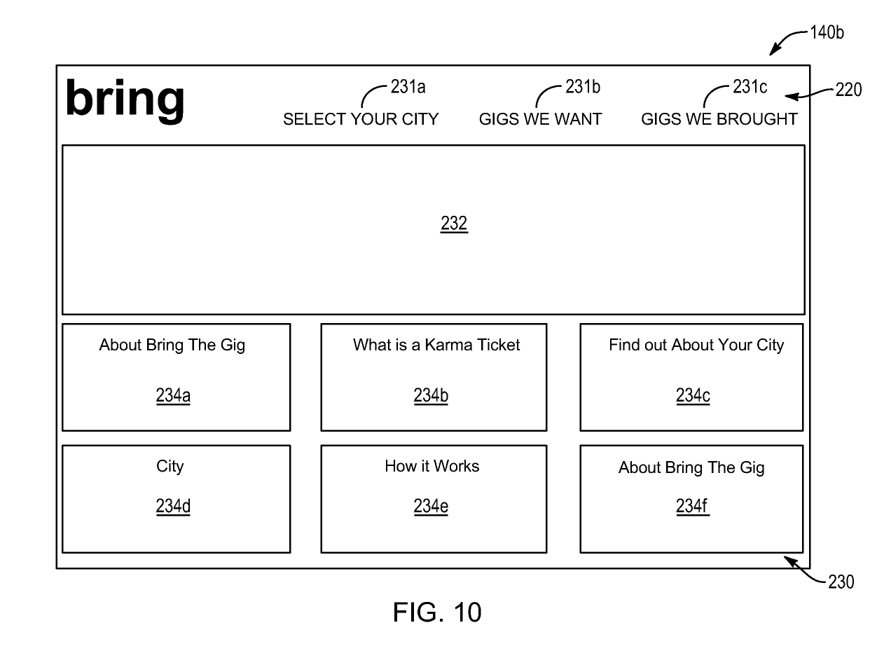

Referring to FIG. 10, a specific page 140b may be prepared as an “about page” 140b. The about page 140b is primarily informational. Although a series of buttons 231 may be presented in a header 220, or header menu 220, they may simply be the same as buttons 221 or hot links 221 on a city page 140a. Alternatively, some of the buttons 231 may be different. For example, a button 231a may enable a user to select their own city, while other buttons may remain the same, such as gigs we want 231b and gigs we brought 231c that may contain hot links, text information presented on the menu 220, or may otherwise access other pages, screens, or simply windows presented on the page 140b in response to clicking by a user.

Typically, a banner 232 will be more of a motivational element and may actually include rapidly presented images of numerous events, a still, a video, or other image.

Likewise, the informational presentations may include plain text such as a text description 234a about the system 68, for bringing a particular talent to an event in a selected city. Similarly, explanations of a front-end-ticket may be included in a blurb 234b, which may or may not include a button or link to obtain more explanation of what a karma ticket is. Karma is a play on words in that a front-end-ticket is one for which a user may put forth more financial investment, but which may result in more refund capacity if a particular band or other talent is more successful.

Likewise, one may access information 234c containing more description about the city, or providing a link to more information about the city. Similarly, other informational buttons 234d, 234e, 234f may refer to the city, how the process 150 works, may identify sponsorship opportunities, may explain the system 68, or the like. As with respect to FIG. 9, any of the panels 234, buttons 234, presentations 234, may include text, images, hot links, buttons, or the like effective to provide the information desired by a user with a click of a button.

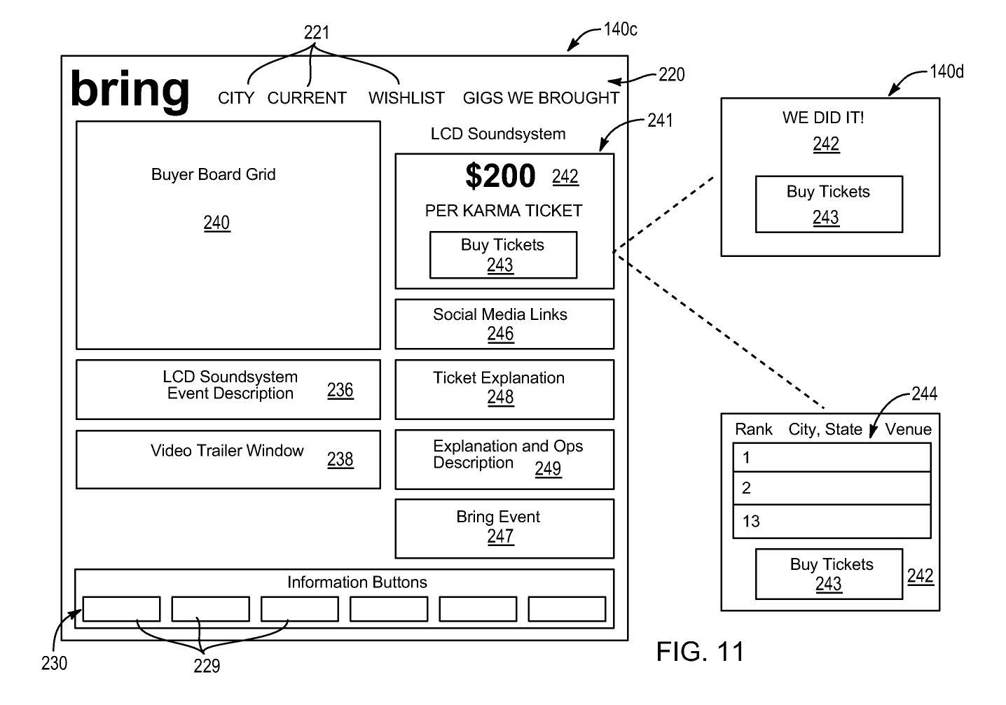

Referring to FIG. 11, a gig page 140c, or event page 140c may rely on a commonly themed format very similar to the other pages 140a, 140b, and so forth. In the illustrated embodiment, the header 220 or header menu 220 may include various buttons 221 such as the city name or information, current events that are being contested or presented, access to a wish list 225, a listing of gigs that have been brought, and so forth. Typically, in a gig page 140c, or event page 140c a major portion of the space may be devoted to windows 236, 238, 240. For example, the window 236 may include an event description, such as the name of a particular talent or band presenting at the event, and may include buttons and links. Similarly, a window 238 may include a video trailer, a montage or video footage from DVDs, or other previous engagements by a particular talent.

Similarly, the window, panel, or element 240 may actually represent a buyer board 240 or grid 240 displaying images. Typically, in one contemplated embodiment in accordance with the invention, numbers or letters, logos, or the like may simply fill all the individual spaces in a grid formation. Upon purchase by a user, a ticket may be represented by each space in the grid. Thus, a user may upload a photograph, avatar, image, logo, or anything else to represent that user. Accordingly, that user, as an attendee or prospective attendee at the specific event may upload pictures to fill in each of the spaces corresponding to tickets purchased by that user. Other individuals accessing the event page 140c may click on any particular image in the grid 240 in order to get information, a profile, a link, or the like desired to be published by that purchaser.

This opens up the sponsorship presentations in which a sponsor may purchase several spaces in the grid 240, which spaces would typically be consolidated together to form a region or space in which that sponsor could advertise. Logos, text, or other information may be uploaded by a sponsor to be presented in the grid 240 in proportion to the sponsorship support. Typically, a sponsor will pay more than an individual for a ticket, because the sponsor is obtaining valuable commercial advertising time and space on the grid 240. Meanwhile, the individual grid elements corresponding to individual purchasers of tickets may be fitted in or flowed around the larger sponsorship portions.

In one embodiment, an information panel may provide information that may be traded out according to the status of a particular contest. For example, in one embodiment an activity panel 242 may simply provide the ticket price, a link, some explanation, or a button 243 in order to activate the purchasing process. Subsequently, the activity panel 242 may be traded out for another panel 242 such as the page 140d, or panel 140d corresponding to a particular event.

Typically, a success page 140d or success insert 140d may simply provide an activity window 242 filled with information indicating the success of the event associated with an event page 140c, meaning that the event 140c will happen. Accordingly, the front-end-ticket price may no longer be illustrated, yet a button 243 may still promote the purchase of market-price tickets, which will be operated on a conventional box-office basis.

Similarly, during a contest, a chart 244 may be displayed illustrating a particular competition. For example, the ranking, the city, the state, and the venue of a particular event may be listed as a competition board 244. In the competition board 244, or chart 244, the ticket button 243 still exists in the activity panel 242, but the ranking information may be presented briefly. A user may click on any ranking information to obtain more detail. Thus, the event page 140c may become an event success page 140d by substitution of the success window 140d in to the page 140c.

In one embodiment, the information panel 241 may include a social media panel 246. The social media panel 246, or social media links 246 may include a plurality of links to such systems as Facebook, MySpace, Twitter, and the like, by which a user inform others. For example, a user may access the social media panel 246 in order to Twitter to others or to share on Facebook the availability of the event identified in the event page 140c. Likewise, a user may simply click on the link 246 in order to forward and recommend the entire event page 140c to friends for their consideration.

Meanwhile, the system 68 may download information that eventually ends up in the database 70 identifying the fact that a particular user has chosen to like, link, share, or Twitter, an event page 140c. Thus, users may obtain a certain amount of credit, voting, weight, votes, or credibility in accordance with their tendency and history of sharing event pages 140c through the social media links 246.

In certain embodiments, promotional information 247 to motivate users may be included in the information panel 241. Explanations, hot links to additional information, and the like may be included to motivate users to help bring a particular event identified in the page 140c. Similarly, an explanation of the operation or description thereof 249 may be included on the event page 140c. In other pages, such as a city page 140a where space is devoted to other matters, the explanations 249 may only be available by hot links.

In contrast, once an individual has expressed an interest by going to an event page 140c, that user may typically want to read more information, and thus have more information presented directly by the various panels 247, 248, 249. Meanwhile, the header menu 220 may exist, and may have changes or modifications, compared to other pages 140, corresponding to the existence of a specific event 140c. Similarly, other information may be displayed in association with information buttons 229 made to be displayed in the footer menu 230. These may be the same as those on other pages 140, or may be unique to the event page 140c.

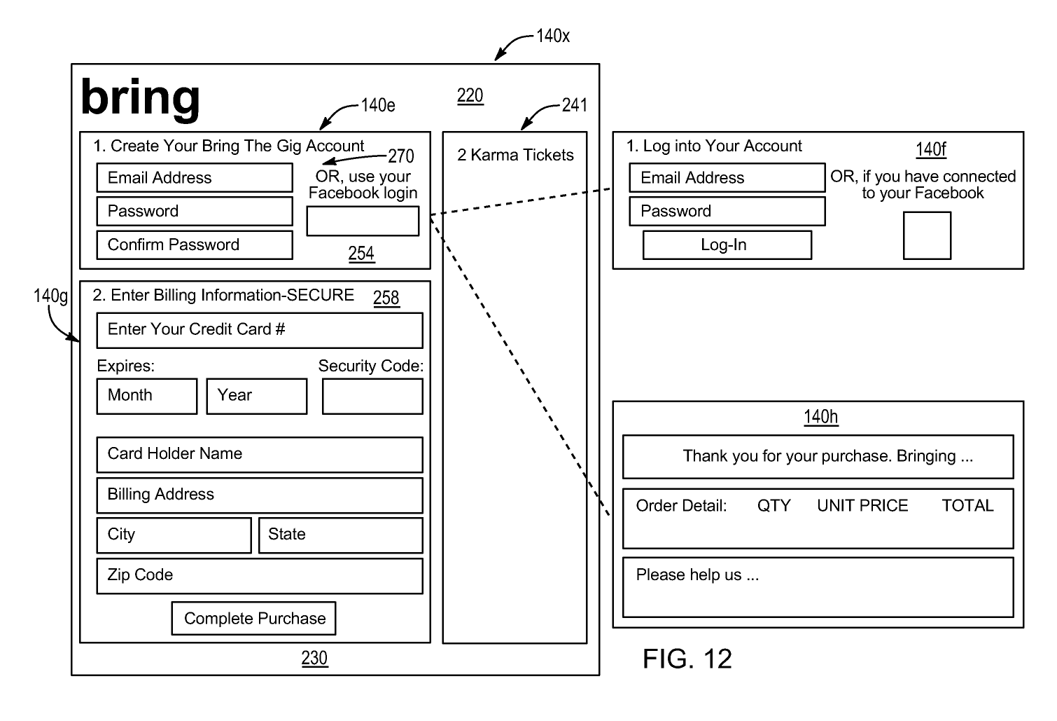

Referring to FIG. 12, a user interface page 140x may effectively provide many of the same features as other pages 140. For example, a header 220, or header menu 220 as well as a footer menu 230 may be provided with the same or other information, buttons, hot links, and the like as illustrated with respect to other pages 140. However, unique to a user interface page 140x may be the sign-up page 140e information embodied as a particular window 140e. That is, for example, a particular window or presentation may be embodied in a page 140 rendering that particular page 140 a new type of page.

Thus, a part or presentation that makes a particular page 140 a user interface page 140x, is its ability to provide for information accumulation from a user. Similarly, to make a user interface page 140x a sign-in page, the sign-in window 140e exists on the page 140x. Thus, the information that will eventually be stored in various records 250 may be accumulated by a page 140.

For example, an individual may provide user information 270 such as an email address, a password, some confirmation of the password repeated, a Facebook or other social media interconnection, or the like.

A user panel 254 may render the user page 140x a check in page 140e. Similarly, the use of a check out information panel 258 may render the page 140x a check out page 140g. Check out information may include a credit card number, expiration date, security code, card owner name, card holder name, the billing address, the city, state, zip code and the like. Similarly, a check out button may be provided to complete a purchase and submit for processing the content of the billing information panel 258.

Meanwhile, the information panel 241 may exist as in other pages 140 discussed hereinabove, or may be altered according to the specific needs of the user interface page 140x.

The information panel 254 may be otherwise replaced in certain presentations. For example, if a user or visitor to the system 68 has not yet created an account, then a sign-in page 140e is appropriate, as illustrated. However, upon subsequent visits, a user interface page 140x may have a sign-in page 140f or panel 140f. That is, a sign-in panel 140f renders the user interface 140x a sign-in page 140f. Here, a previously entered email address, a particular password for the site, and a button for executing the choice to sign in may all be present. Meanwhile, access to social media may be provided by buttons or links in order to sign in or check in through a social media site.

Similarly, a confirmation window 140h or confirmation panel 140h may be placed in the information panel space 254 on the page 140x. This renders the user interface page 140x a presentation of a confirmation page 140h. Appropriate information in the menus 220, 230 and the information panel 241 may be adapted to the specific status and functionality of the user interface page 140x at any particular time.

In some embodiments, one may think of the information gathering as information to be placed into the database 70. Accordingly, information collected may be presented on a page 140, may be stored in the database 70 or both. The database 70 may feed information out to be presented on web pages 140.

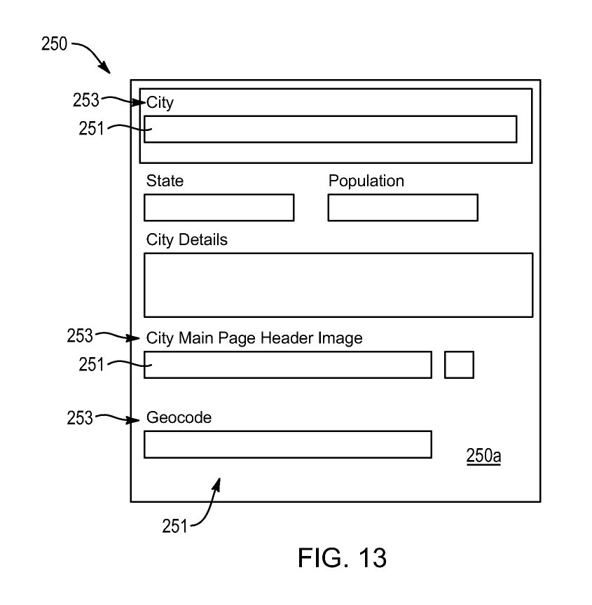

Referring to FIG. 13, for example, a record 250 may include a series of fields 251 to be filled in with information identified by labels 253, titles 253, or the like. For example, in one embodiment, a record 250a also known as a city record 250a may include information such as a city name, state, population, various descriptive text identifying details, and the like.

Similarly, information to be included in logos, banners 216, headers 220, footers 230, or the like, may also be identified in a particular record 250 corresponding to a particular city. Thus, a city record 250a is simply a particular type of record 250 corresponding to a city. Fields 251 unique to a city may be a geo code, for example. In contrast, geography may pertain only to a hometown for a particular talent.

Thus, a record 250 may be adaptive and adapted according to its format, information, and the system of labels 253 associated with each of the fields 251, in order to adapt the record 250 to the information being contained therein. Database technology is well understood, and may be used as the content 134 to be presented according to a template 136 in any display 210 of a particular web page 140 in accordance with the invention.

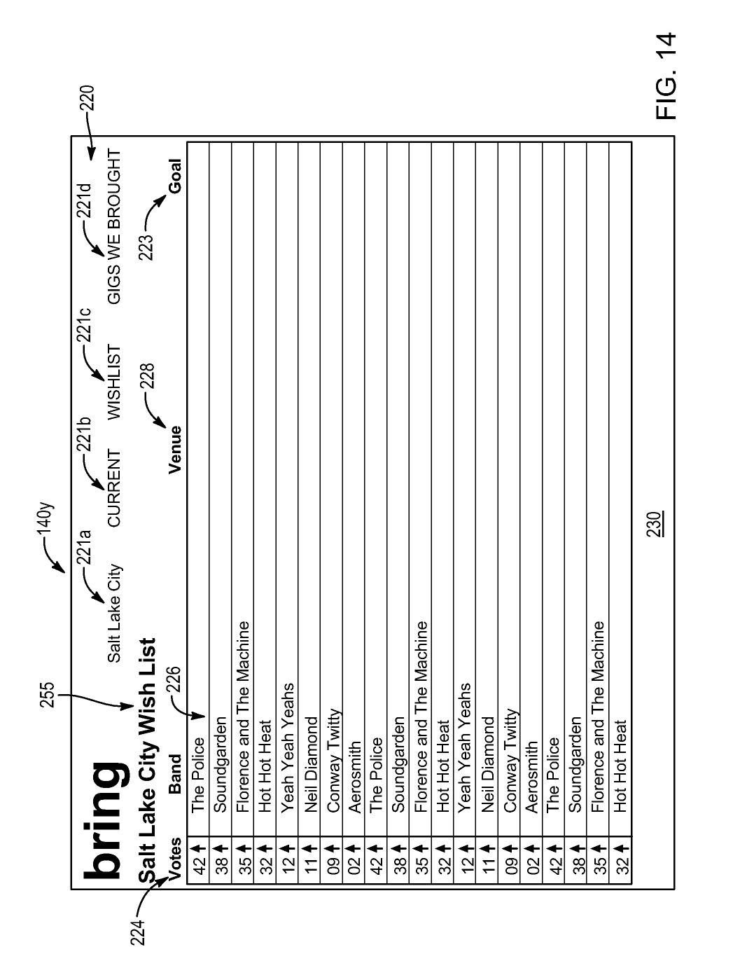

Referring to FIG. 14, a wish list page 140y may include buttons 221a, 221b, 221c, 221d, having information, hot links or the like in a header menu 220. Similarly, a footer menu 230 may operate as in other pages discussed herein above. Typically, a wish list page 140y includes a list 224 of votes, various bands 226 or a list 226 of bands or other talents, a list of venues 228 and the goals 223 or financial receipts that must be achieved in order to bring any particular talent from the list 226 to a particular city. Typically, the wish list page 140y may also be thought of as the detail page 140y of the wish list 225 on the city page 140a. By providing a wish list page 140y, the wish list 225 may be displayed in as much detail as desired. It need not omit details and numbers of potential talents limited by the space available on the city page 140a.

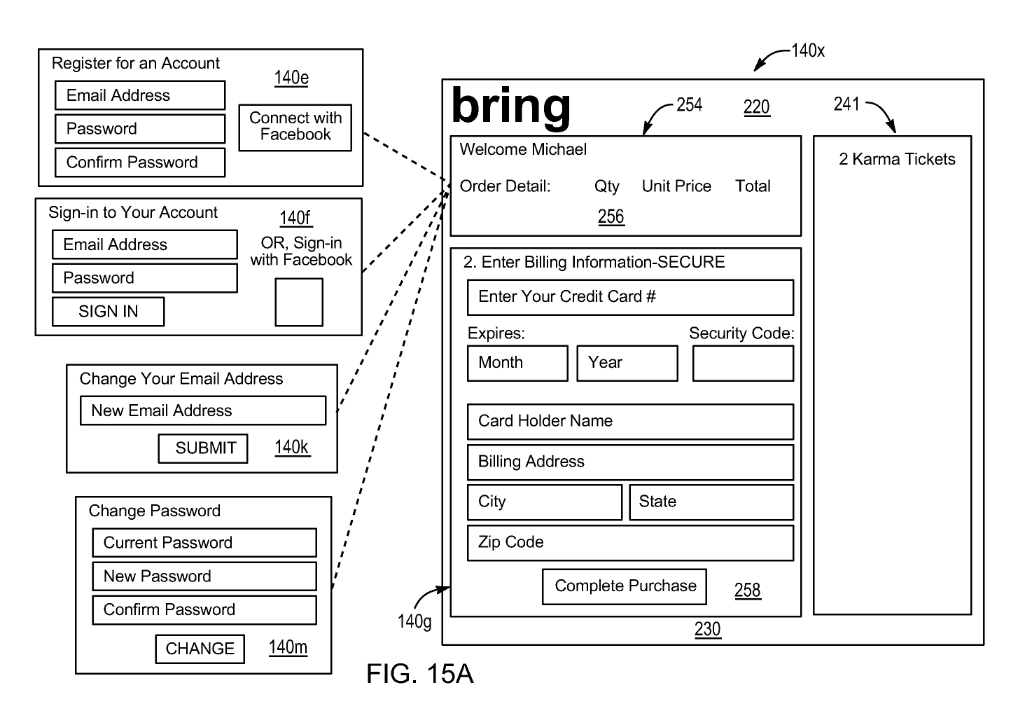

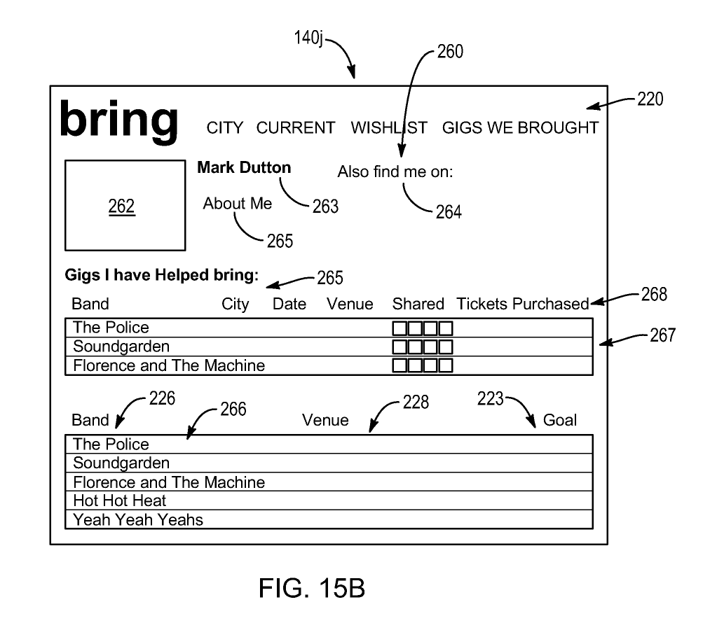

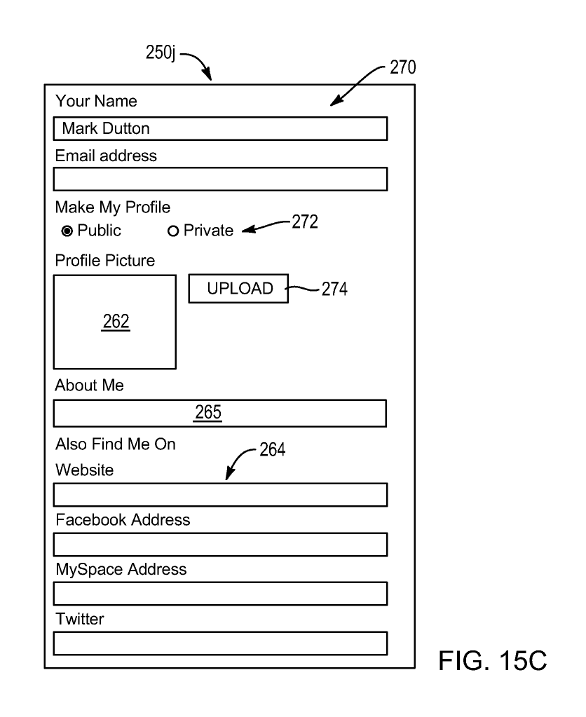

Referring to FIG. 15A, a user interface page 140x may be embodied as alternative versions such as a sign-up page 140e, when the sign-up panel 140e renders the user interaction page 140x a sign up page 140e. Similarly, a sign in panel 140f renders the user interface 140x a sign in page 140f. Meanwhile, execution of clicks on various buttons may provide for the user to update certain contact information, such as the update panel 146, 140k, which renders the user interface page 140x an update page 140k.

Similarly, a user interface page 140x may include a security panel 140m rendering the user interface page 140x a security page 140m. For example, a user may be presented with different information in a user panel 254. Similarly, the header menu 220 may be the same or different from the menus 220 in other pages 140. Also, the footer menu 230 may be the same as or different from the footer menus 230 on other pages.

Meanwhile, in the illustrated embodiment of FIG. 15A, a check-out page 140g results when the billing information panel 140g is presented in the user interaction page 140x. Thus, a user may be presented with check out information 258, some of which will be presented by the system 68, and some of which will be input by a user.

Accordingly, the user panel 254 may at one point substitute any of the other user sign up, sign in, change, or other information with a receipt panel 256 identifying order details, quantities, prices, total amounts. The user interaction page 140x after log-in by a particular user may be personalized to include the user's name and other identifying information previously provided by the user, or stored association with the user's user page 140x. Some information is more appropriately stored in the record 250 corresponding to a user as stored in the database 70 for retrieval and display on the page.

Meanwhile, an information panel 241 may be included on the page 140x as appropriate.

Referring to FIG. 15B, in one embodiment, a profile page 140j may include a presentation of information contained in a profile record 250j as illustrated in FIG. 15C. In general, for purposes herein, it may be proper to refer to any particular page 140 as a record, inasmuch as a particular page 140 may present the same information from a particular record 250. In the case of a user profile page 140j, included information may provide for an image panel 262 containing a picture selected by a user. The image panel at 262 or image 262 contained on the page 140j may be a picture of the user or some other choice, such as an avatar, a slogan, a favorite image from elsewhere, or the like.

The profile 260 may include a name, a field 265 containing information about the person identified by the name 263, as well as a social media field 264 identifying other social media sites whereon this user may be found. Thus, an individual may click on a particular image on the grid 240 illustrated in FIG. 11, and from that particular gig page 140c, identify an individual user by name 263. An individual may then find a profile 260 on a profile page 140j corresponding to the name 263.

Depending on the settings a user chooses to place on a profile page 140j, other users may contact similarly interested users to discuss bands, concerts, venues, or other details associated with various events presented by the system 68. In the instant illustration, the social media cross-references 264 may show individuals a way to contact one another by searching for the desired name 263 on a social media site.

Meanwhile, a history 265 corresponding to a user name 263 may include various talents, cities, dates, and venues of particular gigs that a user has attended. Accordingly, various headings 268 may identify the information 267 provided in the histories 265 of a user. For example, social media through which an individual has shared information or attendance at a particular event may be included. Meanwhile, tickets purchased, and the like may also be included.

In the illustrated embodiment, various bands 226, or lists 226 of bands may be included in a preference 266, or preference profile 266. For example, whereas the history 265 indicates events that an individual has helped to bring, the preferences 266 will illustrate or otherwise identify events, talents, and venues the user desires to attend in the future.

In general, headers 220 and footers 230 containing the various menus or adaptive menus may be included in any particular web page 140, such as the user profile page 140j.

Referring to FIG. 15C, a record 250j corresponding to the user page 140j or profile page 140j may include information that populates the various fields in the page 140j. For example, in the illustrated embodiment the headings 268 on the presented page 140j may be more or less fixed.

In contrast, the content 267, or the information 267 is typically drawn from fields 251 of records 250. In particular, a profile record 250j corresponds to a particular user and will contain user information 270. User information may range from name, email address, and other contact information to security settings 272 or security selections 272 regarding distribution. Likewise, a profile picture 262 may constitute the image 262.

Thus, the image panel 262 contains the profile picture 262 from the record 250j. Likewise, a control button 274 may direct the system 68 as to when to upload the content of the record 250j to the database 70, in order to be displayed in the profile page 140j. Meanwhile, the history 265, presented on the profile page 140j may be contained in the history 265 of the record 250j. That is, the history 265 in the record 250j corresponds to the content displayed in the history 265 of the user profile page 140j.

Similarly, the social media cross-references 264 in the profile page 140j receive their content from the social media cross references 264 contained in the profile record 250j.

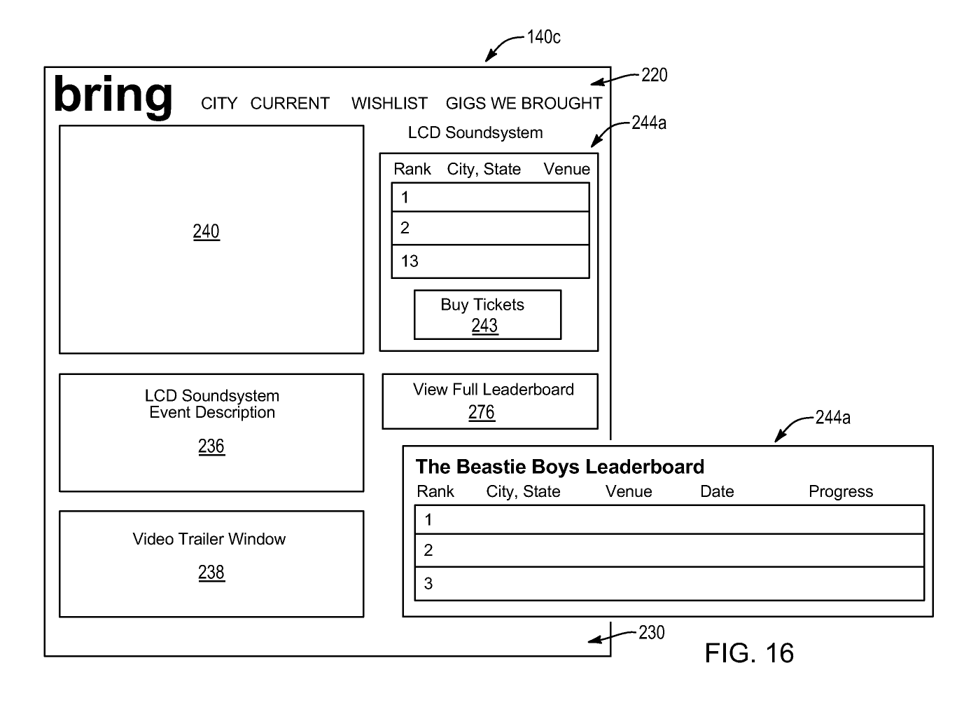

Referring to FIG. 16, gig page 140c or an event page 140c in certain embodiments may include a chart 240a identifying a leader board 244a. However, by clicking on a particular button, or a particular element within the abbreviated leader board 244a shown on the event page 140c, may result in expansion thereof on the page 140c, or presentation of a different page 140 that contains the full details of the leader board 244b.

For example, a view button 276 may be selected by a user in order to view the full leader board 244a. The leader board 244b then presents not just the rank, city, state, and venue, but particular dates, competitions, progress, and the like.

Referring to FIG. 16, an event page 140c may include a view button 276 controlling the view of the leader board 244a. The leader board may involve a description of the particular leaders in competition. For example, various cities may compete and may exists in various states, while all compete for the same particular talent on a particular day.

Accordingly, a user may click on the view button 276 in order to view the entire leader board 244a of a competition, voting, or the like as a leader board 244b detail. Accordingly, rather than simply the rank, city, state, and venue, the additional space of the expanded leader board 244b may provide for dates, progress and competitions, and other details useful to users.

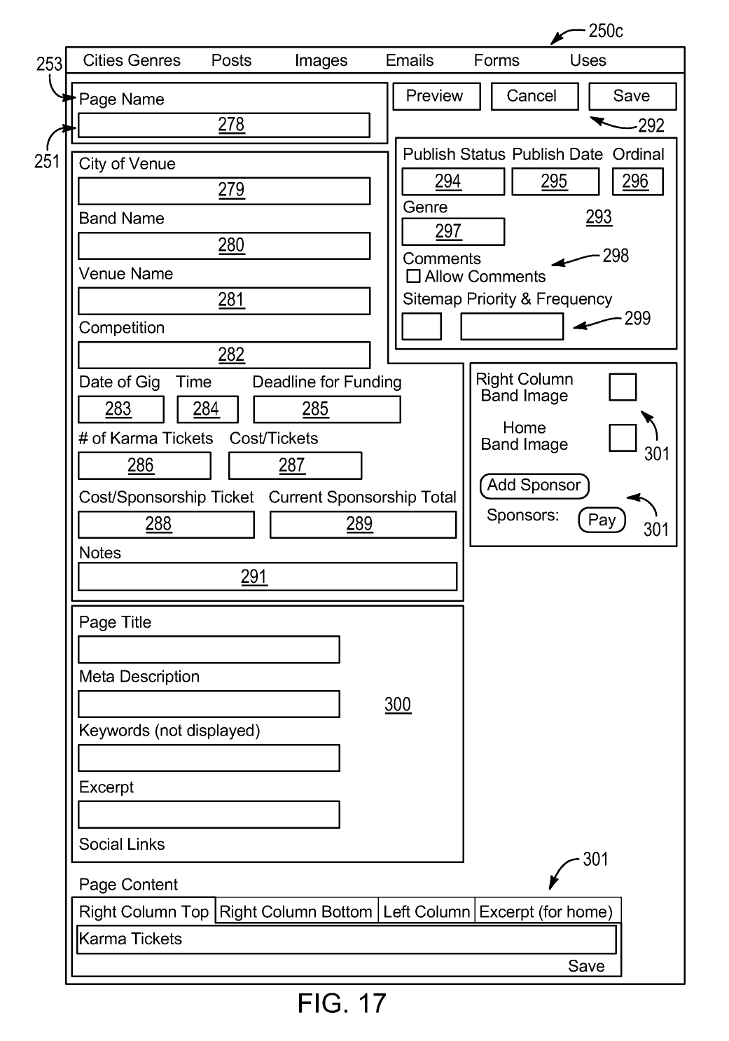

Referring to FIG. 17, a record 250c may be presented to an administrator of the system 68 in a format similar to pages 140. For example, the header menus 220 and footer menus 230 may still surround the presentation of a record 250c on a computer screen presented to an administrator. In the illustrated embodiment, the various fields 251, with associated titles 253, or names 253, will be populated according to the function of the record 250c.

In this instance, a page name 278 may be reflective of a particular event, by name of the talent, city, date, and venue of a concert, or the like. Typically, a name of a talent, a city, and a date will typically identify a particular event. Therefore, a city 279 and a talent 280 as well as the venue 281 may all be named.

Similarly, the competition field 282 may actually include key information about a competition, such as a flag indicating whether a competition is being run, the name of a competition or any other information that may be useful. Whether a city is in a competition or just determining a go/no-go decision for an event, a date 283, time 284, and deadline by which funding must be guaranteed are also typically information required by an event record 250c.

Typically, the controlling parameters are the deadline 285 by which funding must be achieved, and the total amount of money as defined by the number of karma tickets 286, or front-end-tickets 286, and the costs 287 for each of those tickets. The product of these two numbers amounts to the minimum total sales (gate or box office receipts) that must be received before the deadline 285 in order for the event 278 to occur. That is, the page name 278 may effectively be the event name 278 however that is specified.

A cost 288 for sponsorship tickets will typically be a premium price greater than the cost 287 of a karma or front-end-ticket 286. Accordingly, the total amount of sponsorship money may be displayed as the total 289. Typically, other management notes, including requirements of contracts and the like may be included in the notes field 291.

The record 250c or event record 250c may include a number of fields 251 labeled with appropriate names 253. The particular information associated with a particular event may include, for example, the talent name 280, the venue name 281, the city 279 in which the event will occur, as well as a name 282 corresponding to the competition for that event. Since various cities may compete, competitions may identified by the talent, the cities, the dates, or any other particulars that may be useful. Typically, a date 283 and time 284 with a deadline 285 for funding may be included. Of course, the total funding amount may be included, and is typically a product of the number of front-end-tickets 286 sold, as well as the cost 287 of each of those tickets. The cost 288 of a sponsorship ticket obtains advertising in the grid 240 on the displayed event page 140c. Thus, the value 288 of a sponsorship ticket, along with the current total value 289 of a sponsorship payments may be displayed. Notes 291 may deal with contractual obligations, reminders, logistics, or the like as appropriate.

The control buttons 292 may be specific to the web pages 140 presenting a record 250c, but may typically be common to many types of records. For example, the ability to preview, cancel, or save a record will typically be useful for each record. Meanwhile, a navigational menu 290 may be placed as a menu 220 or header menu 220, and may include information that an administrator for the system 68 may need. For example, to navigate away to other information and have it presented on the record 250c may be one function of the control menu 290.

Another purpose may be to simply navigate away to another record 250 corresponding thereto. In one embodiment, a user may use the various buttons to access various genres for selecting one to correspond to a particular event. Meanwhile, various posts or pages related to the record 250c may be identified or accessed through the menu 290.

Images that may be presented in a page corresponding to the record 250c may be accessed. Likewise, emails, forms, messages received, and the like may be reviewed for information that can be used in the record 250c, to eventually be displayed on a page 140c corresponding to the record 250c.

In the illustrated embodiment, a publication window 293 may include such things as a publication status 294, a publication date 295, an ordinal 296 for version control or ordering in the case of multiple records 250c. A genre indicator 297 guides administration of the record 250c, and its subsequent presentation as a page 140c. Typically, comment control 298 may provide control over whether or not user comments will be published, and various site map priority and frequency information 299 may be presented.

Typically, advertising copy 300 in the form of various promotional materials, comments, headers, quotes, and the like may be presented. Typically, a page title that will actually be displayed on a particular page of 140c may be included, meta description data that will control presentation, key words to be used for searches and the like but not necessarily displayed, as well as excerpts, such a quotes and comments to promote a particular talent, may be included. Typically, social links that are supported will also be included in the advertising copy information 300.

The other information 301 may involve control of the record 250c, or control of its presentation in a corresponding page 140c. For example, the content of the page 140, and its location in the right or left column, the top or bottom portion of the column, as those are laid out in the particular format, may be use as navigational aids by an administrator. Thus, the navigator may click on various buttons displayed or corresponding to the information 301 presented, in order to bring up other pages or windows to control, review, or edit, content associated with the record 250c, or included in the record 250c, to effect the presentation in the corresponding page 140c.

Meanwhile, the presence or absence of various banners or band images may be identified, and various control buttons to add sponsors, have them pay, or the like, may be indicated. Again, a record 250c deals primarily with the information that may control, or be presented, whereas the page 140c corresponding to a event, and thus an event page 140c will actually present the information as controlled by the data in the record 250c.

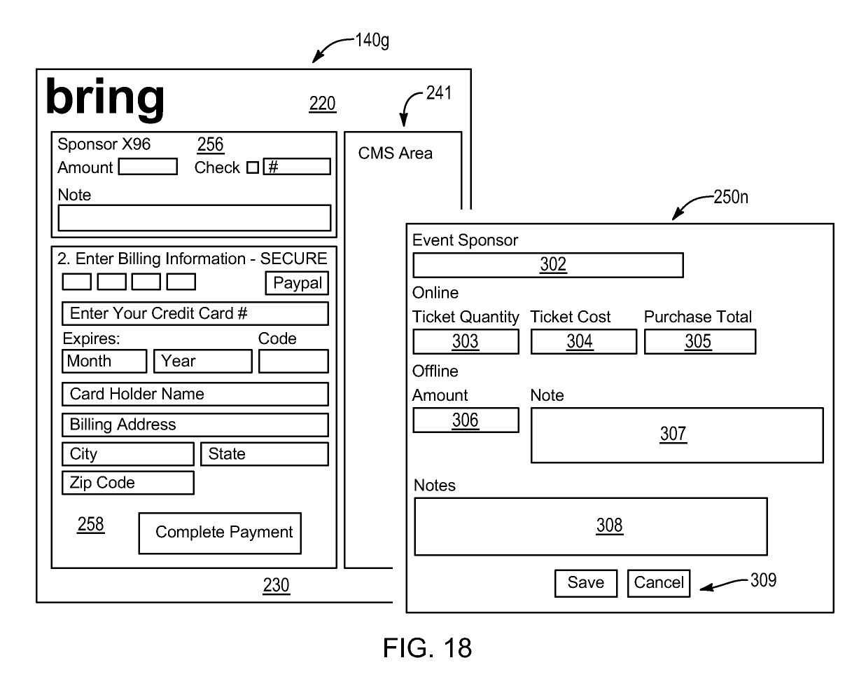

Referring to FIG. 18, a sponsor page 140n may be configured as a checkout page 140g and may change in content compared to a checkout page 140g of a user. For example, the header menu 220 and the footer menu 230 may be essentially the same as those for other pages 140. Nevertheless, they may include buttons, information, links, and the like particular to a sponsor or to the checkout page 140g as it would be accessed and used by a user computer of a sponsor.

In the illustrated embodiment, a checkout page 140g adapted to a sponsor may include an information panel 241 as described hereinabove. Likewise, the information may be very similar. For example, information including various logos or buttons bearing the logos of different debit and credit cards may be displayed along with a button for a pay service such as paypal or the like. Meanwhile, the field for entering a credit card number, expiration date and year, along with security code may be required along with the name of the card holder, a billing address, a city, state, and zip code.

A completion button may indicate submission of a payment may be prominently displayed and may be colored to be highlighted. Meanwhile, the receipt information 256 or receipt panel 256 on the page 140g may be adapted to the conform to content and format of a sponsor purchase. Typically, an amount of money, rather than a particular number of tickets may be the appropriate designation. Similarly, a check number, purchase order number, invoice number, or the like may be presented.

Likewise, notes communicating from the sponsor to the administrators of the system 68 may be presented in the appropriate field of the receipt information 256. In other embodiments, or even the illustrated embodiment, notes may travel in either direction, thus providing for notes from the administration to the sponsor or notes from a sponsor identifying exactly what terms or references may be appropriate.

Inset with the checkout page 140g, is the sponsor record 250n. Typically, only the administrator accesses a record 140. Nevertheless, the information in the record 250n may be used to present a page 140 corresponding thereto or may be stored in a page 140.

In the instant example, the name of an event sponsor 302, along with a quantity 303 of tickets or purchase advertising space, and the cost 304 per unit may be indicated. Accordingly, a purchase total 305 may be required. Typically, notes in the checkout information may include identification of a particular event, how payment is to be distributed among various in kind donations or the like.

For example, a sponsor may be a radio station. That radio station may make a certain amount of its payment in radio advertising for the event corresponding to an event page 148. The use of the advertising funds paid by a sponsor may be earmarked for specific support such as banners, T shirts, and the like that tend to promote the event, and the sponsor, but will not be necessarily be transferred to cash. Thus, terms of contracts, and the like may be entered into the notes fields.

Similarly, in a note field 307 of a sponsor record 250n, an amount of a payment may be shown, while the note 307 shows where or how the payment will be applied. In certain embodiments, the content of the note 307 may be displayed in the note field of the receipt panel 256. Thus, the information regarding the type, allocation, and terms of a payment may be stored in the record 250n and displayed in the payment page 140g or checkout page 140g corresponding to a transaction sponsor.

Control buttons 309 indicating saving, cancelling, uploading, and the like may be embodied in the presentation of a record 250n. Notes 308 may be included such as “attention” to names of persons to which administrative information directed, an indication of how funds will arrive, (e.g. by check, by in-kind payments), or the like may also be included as overall notes 308 important to the administration of the records 250n for a particular sponsor.

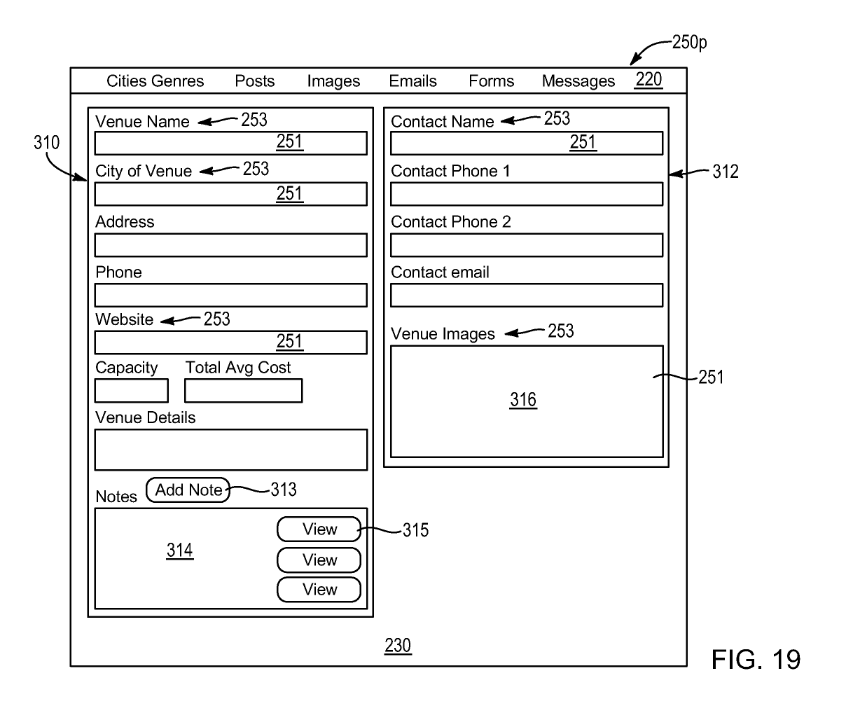

Referring to FIG. 19, a venue record 250p may be presented in a page 140 corresponding to a venue. Typically, a venue record 250p will only be accessed by an administrator. Thus, the header menu 220 may or may not be matched by a footer menu 230. Meanwhile, the principle content of the record 250p may include, for example, a series of titles 253 or names 253 with their corresponding fields 251 identifying important information. The name, city, address, phone, website, seating capacity, average cost of the venue or of seating in the venue, and other venue details may be provided in a panel 310 representing a field 251 of the record 250p.

Various names of contacts associated with any entity, with their phone numbers, email, and other contact information, may be presented. Mailing addresses may be used, but in the modern world email seems to be more important. Meanwhile, however, control buttons 313 may provide addition of notes 314 and control buttons 315 may open up those note entries 314 for viewing in detail.

An image field 316 may receive and store images used for advertising. For example, venue images may include logos, signs, slogans, and the like. Various trademark images may be stored in the image field 316 in order to be used on an event page 140c and particularly in the grid 240 associated therewith.

In some embodiments, venue images may include such things as a seating chart, a seat allocation chart for filling up by assigned tickets, images of the interior of a venue, and the like. Venue advertising by way of either pictures or other trademark materials may be presented on various pages 140, and particularly the event page 140c.

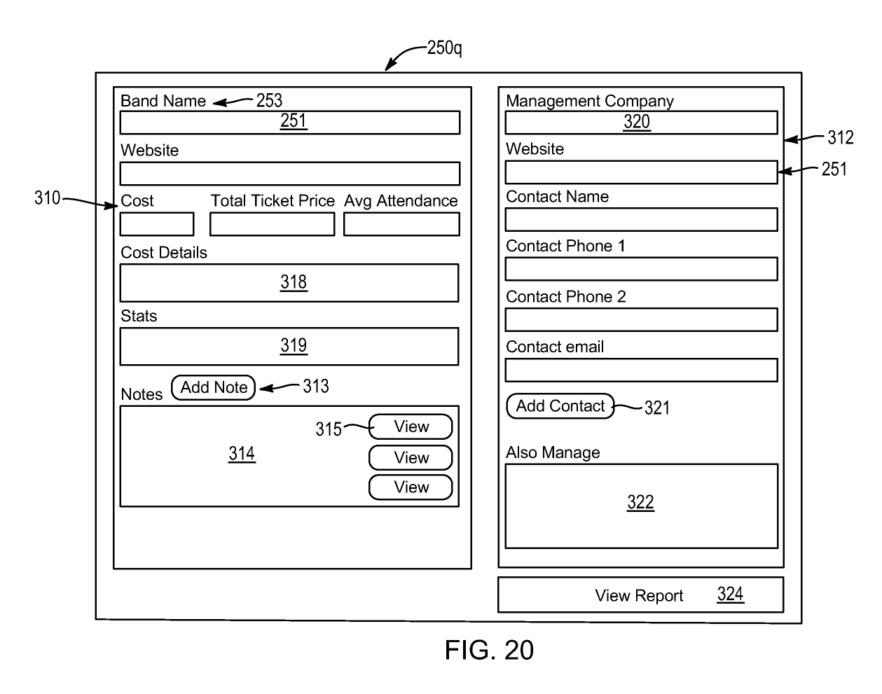

Referring to FIG. 20, as with venues and other entities, talents, such as bands, performers, artists, and the like have records 250q in the data base 70. Typically, a performing group or individual representing the talent, such as a band, may be represented by information stored in fields 251 identified by labels 253 or names for those fields 251. Typically, the contact information, such as the name of the band, its web site, and the like, may be included in the record 250q.

Typically, the cost of having the talent perform at a particular event will be key to operation of the system 68. Meanwhile, the total ticket price, average attendance, and so forth as well as a breakdown of cost details for a particular event, or for past events may be useful. For example, cost details may specify that a certain percentage of the box office is provided for overhead, and that a certain percentage is payment to the talent. In other embodiments, a flat percentage of the entire box office receipts, including the front end ticket sales, may be required, with a specification of what overhead of the talent that will also include. Similarly, certain expenses may be tacked on in addition to the gate or the box office receipts.

In certain embodiments, notes 314 may be added with a control button 313 in order to document communications, requests, obligations, and other arrangements. Similarly, by use of the control buttons 315, the notes 314 may be read. Meanwhile, a control button 313 may provide for addition of notes.

Typically, the cost details 318 and statistics 318 may be required or helpful. Typically, statistics will give a past history, thus indicating in the talent record 250q or record 250q the expectations for attendance in venues supported by certain sizes of populations. For example, a city of 100,000 people would not be expected to draw the same crowds to a venue that could be commanded by a population of half a million or a million. Thus, the talent record 250q may be very helpful to a processor 12 in finding potential talents for use in competitions and presentation to users on a particular city page 148.

The contact panel 312 may include the name of a management company 320 or manager 320 responsible for contract negotiations on behalf of a talent. Thus, the website, a contact name, phone numbers, contact emails, and the like may be necessary in order to communicate effectively with the management 320. Similarly, control buttons 321 may provide for adding additional contacts, including contacts within the group if the talent is a group, but typically may simply be other contacts within a management company.

Importantly, it may be beneficial to know other talent managed by a particular management company 320. Accordingly, a field 322 may include other talent 22 managed by the management company associated with a particular talent record 250q. Control buttons such as view button 324 may link to various reports such as voting, and the like. A voting report may identify what the voting revealed for a particular city contest involving the band. That voting report may become a successful concert, or a cancelled concert.

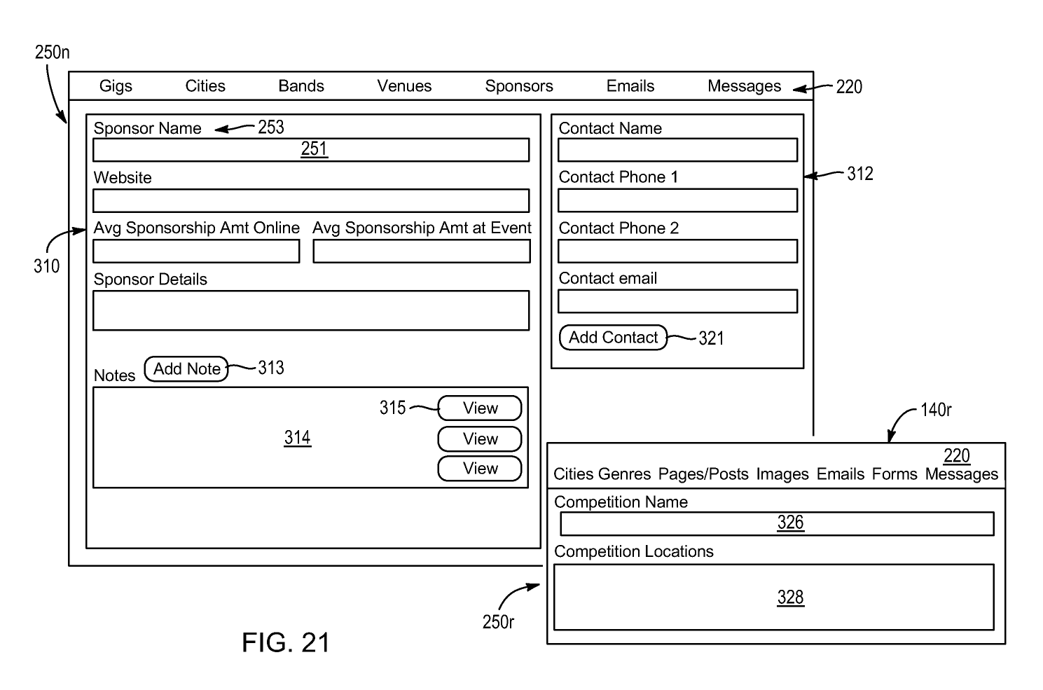

Referring to FIG. 21, a competition page may be structured similar to other pages with header menus 220, footer menus 320 and the like. Typically, a competition page 140r may include a competition name, 326, and a competition location 328. The menus 220, 230 may provide control buttons to access other details associated with the competition name 326, which may reflect the venue, the talent, and so forth. Typically, the competition record 250r may be used to feed information to a competition page 140r. Thus, it may be appropriate to speak of a competition record 250r as a competition page 140r simply because the record 250r may actually be the content store of the data base, and the page 140r only the presentation of that information.

In the illustrated embodiment of FIG. 21, the competition page is shown as an inset accessible or otherwise associated with a record 250n corresponding to a sponsor of a particular competition. Typically, various sponsors are associated with a competition, and ultimately with the resulting event, if the event occurs.

Nevertheless, during the process of a contest to bring a particular talent to a venue in a particular city corresponding to a sponsor, this sponsor pays for advertising on the grid 240 of the city page 140a. Accordingly, the sponsor record 250n may include a panel 310 containing various fields 251 with their labels 253 identifying a sponsor name, website, average sponsorship amount paid online, average sponsorship amount paid at an event, and various other sponsor details. Again, control buttons 313 may provide for the addition of notes 314, which may be accessed in their entirety by control buttons 315.

Sponsor details may be added including the terms of particular agreements such as free tickets, exchanges for air time, and the like. Typically, a sponsor record and a competition page 140r may be accessed from each other. However, records 250 are typically only accessible by administrators of the system 68 or by automatic execution of software of the system 68. Thus, although, various users may be able to access a competition page 140r, only an administrator could access the record 250n from the competition page 140r. Typically, the contact, name, phone number, email, and the like may be provided in any particular record 250 associated with any entity. Similarly, a control button 321 to add contacts, and so forth may be part of the record presentation.

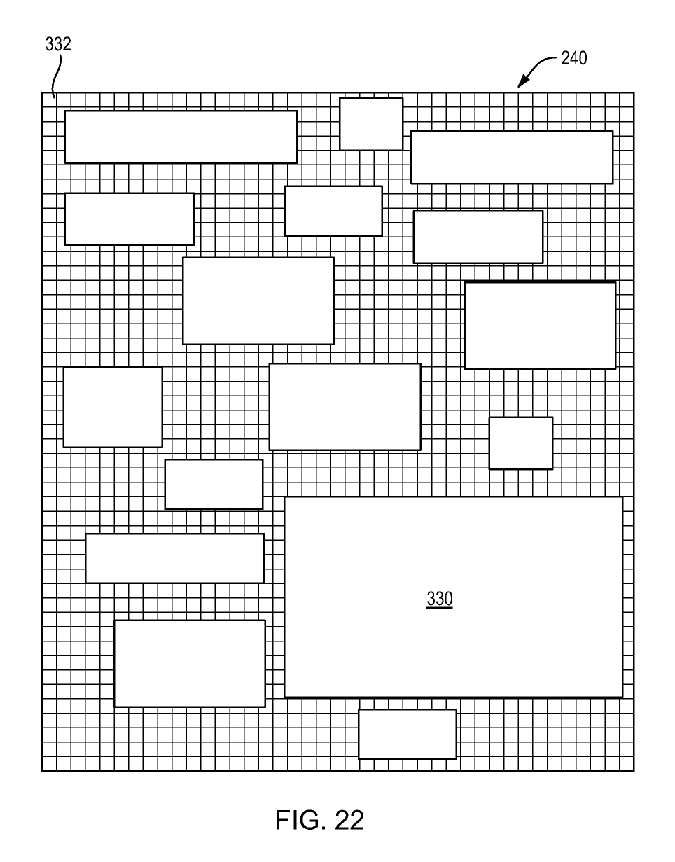

Referring to FIG. 22, the grid 240 may include various elements 332 wrapped around various regions 330. The regions 330 may correspond to large purchasers, or purchasers of large numbers of tickets. Typically, sponsors may choose to guarantee certain numbers of ticket sales in return for advertising space. Likewise, various sponsors may give away tickets. Accordingly, sponsors may obtain regions 330 of consolidated space around which the individual elements 332 will be streamed to fill in the difference. Thus, each of the aggregated sponsor regions 330 may include a presentation of a logo, advertising, or the like for a particular sponsor.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A computerized method to create and analyze a prospective event according to direct inputs of customer values from users and corresponding to selection criteria, the method comprising:
providing a processor comprising a central processing unit programmed to fetch, decode, and execute instructions;
providing a memory comprising a computer readable storage medium operably connected to the processor to pass instructions to the processor for execution;
storing in the memory a database comprising records in sets corresponding to entities, events, and locations;
connecting the processor to the Internet to send and receive data directed to and from the database with respect to the users;
receiving from the users, over the Internet, parameters corresponding to and defining the prospective event;
analyzing, by the processor, the parameters; and
selecting and structuring the prospective event in accordance with the values of the parameters received directly from the users.

2. The method of claim 1, wherein the values correspond to user data reflecting a history of a user and previous events.

3. The method of claim 2, wherein:
the parameters correspond to votes accounted by users identifiable by and identified by the processor;
the database is programmed to maintain a record corresponding to a participation history of each user of the users; and
votes of each user are weighted in accordance with the participation history thereof.

4. The method of claim 3, wherein the participation history includes at least one of:
an attendance number, reflecting a events attended by the each user;
a purchase number reflecting purchases of the each user;
an influence number reflecting attendance at previous events by other attendees as a result of actions of the each user; and
a leader number reflecting attendance at previous events by other attendees as a result of opinions expressed by the each user.

5. The method of claim 4, wherein the participation history includes at least one of:
talents performing at the previous events;
genre corresponding to talents performing at the previous events.

6. The method of claim 5, wherein the participation history includes at least one of:
a voting number reflecting a correlation between the events attended by the each user and the voting history of the each user;
a voting weight reflecting an equation defining the voting weight as a function of the participation history of the each user; and
a prediction number reflecting an equation defining the prediction number as a correlation between successful events of the previous events and the participation history of the each user.

7. The method of claim 6, wherein the method further comprises:
storing in the database user records reflecting the each user as an entity;
storing in the database event records reflecting the previous events;
storing in the database venue records reflecting locations at which the previous events were held; and
storing in the database talent records reflecting success of performances at the previous events.

8. The method of claim 7, wherein analyzing the parameters further comprises calculating financial projections corresponding to a proposed event based on the values of the parameters selected from at least two types of records including the user records and another record selected from:
the event records;
the venue records;
the talent records;
financial records;
city records; and
ticket prices corresponding to the previous events.

9. The method of claim 1, further comprising:
analyzing, by the processor, event data corresponding to the prospective event;
calculating, by the processor, a front-end ticket price;
calculating, by the processor a back-end ticket price;
publishing over the Internet, by the processor, the front-end ticket price;
analyzing, by the processor, a front-end value reflecting sales of front end tickets at the front end ticket price;
triggering, by the processor, publishing over the Internet the back-end ticket price based upon the analyzing the front-end value compared to a front-end threshold value.

10. The method of claim 9 further comprising:
triggering, by the processor, calculation of reward values based upon a back-end value reflecting sales of back-end tickets at the back-end ticket price;
calculating and providing, by the processor, rewards in kind to the users based on the user record, the reward values, and the back-end value.

11. A method comprising:
registering, by a processor, users over the internet;
creating, by the processor, user records corresponding to users registered over the Internet to be identifiable and tracked by the processor;
providing, by a processor, an input request receiving over the internet from the users a user identifier and suggested values selected by the users and reflecting at least two of a prospective event, a prospective talent, a prospective date, a prospective venue, a prospective ticket price, and a prospective city;
evaluating, by the processor input data received and reflecting the suggested values;
calculating, by the processor at least two of
a front-end ticket price,
a threshold reflecting a number of front-end tickets required to be purchased before a prospective event can be confirmed, and
event data defining the prospective event based on the evaluating;
publishing, by the processor, over the Internet at least two of
the event data,
the front-end ticket price, and
a deadline by which the threshold must be met in order to confirm the prospective event; and
selling, by the processor, over the Internet, a portion of the front-end tickets.

12. The method of claim 11, further comprising selling, by the processor, back-end tickets at a back-end price less than the front-end price after determining by the processor that the threshold has been met before the deadline.

13. The method of claim 11, further comprising:
providing a database accessible by the processor and storing records including
event records containing event data corresponding to a prospective event,
calendar data corresponding to available dates,
venue records corresponding to prospective venues,
talent records corresponding to prospective talents,
city records corresponding to cities of the prospective venues, and
user records corresponding to users registered to submit at least one of a recommendation of data for inclusion in the records and a vote for a record of the records for selection as part of a definition of the prospective event.

14. The method of claim 13, further comprising populating the database by soliciting from users, over the Internet names of entities for which to create records.

15. The method of claim 14, further comprising:
receiving, by the processor, from the registered users, votes weighted to reflect the user records;
analyzing, by the processor, the votes to determine a prediction of success of the prospective event, based on the votes and weights corresponding to each of the votes; and
configuring, by the processor, a selected event, based on the analyzing.

16. The method of claim 15, further comprising:
analyzing, by the processor, the selected event to provide a deadline corresponding to the selected event;
calculating, by the processor, a front-end ticket price for a front-end ticket to attend the selected event and purchased before the deadline.

17. The method of claim 16, further comprising:
calculating, by the processor, a back-end ticket price for a back-end ticket to attend the selected event and purchased after the deadline.

18. The method of claim 17, further comprising:
selecting, by the processor, a threshold reflecting required sales of front-end tickets;
analyzing, by the processor, front-end sales of front-end tickets over a period of time before the deadline; and
determining, by the processor, before the deadline, whether to cancel the prospective event, based on a projection of probable sales of front-end tickets resulting from the analyzing.

19. The method of claim 11, further comprising:
analyzing, by the processor, front-end sales of front-end tickets over a period of time before the deadline;
determining, by the processor, before the deadline, whether to cancel the prospective event, based on a projection of probable sales of front-end tickets resulting from the analyzing;
canceling, by the processor, the prospective event;
calculating, by the processor, refunds for the front-end sales; and
providing, by the processor, based on a user record of each purchaser, a communication to the purchasers of the front-end tickets offering a choice of kind of refund, the kind being selected from gifts, tickets, discounts, downloads, and upgrades corresponding to at least one of the entities corresponding to the prospective event that was canceled.

20. The method of claim 11, further comprising:
calculating, by the processor, contract criteria corresponding to an option contract obligating at least one of prospective talent and prospective venue to commit by the deadline at the threshold value;
calculating, by the processor, parameters defining the prospective event based on voting by users and user records containing information reflecting user participation in previous events;
publishing, by the processor, over the internet, web pages comprising an event page disclosing the scenario, including selected data from an event record corresponding to the prospective event;
analyzing, by the processor, the contract criteria based on total sales of the front-end tickets compared against the threshold; and
authorizing, by the processor, a box office computer to sell back-end granting admission to the prospective event at the back-end ticket price less than the front-end ticket price;
defining, by the processor, in accordance with profiles corresponding to the users imaging regions on a web page, demarcated in incremental spaces; and
presenting personal images corresponding to user profiles from user records, based on purchase of front-end tickets.
